(19) United States
(12) Patent Application Publication
(10) Pub. No.: US 2010/0313687 A1
(43) Pub. Date: Dec. 16, 2010

(54) STIRRING DEVICE AND ANALYZER

(75) Inventor: Hiroyuki Ogusu, Shizuoka (JP)

Correspondence Address: Townsend and Townsend and Crew LLP, Two Embarcadero Center, 8th Floor, San Francisco, CA, 94111, US

(73) Assignee: Beckman Coulter, Inc., Brea, CA (US)

(21) Appl. No.: 12/860,740

(22) Filed: Aug. 20, 2010

Related U.S. Application Data
(63) Continuation of application No. PCT/JP2009/053086, filed on Feb. 20, 2009.

(30) Foreign Application Priority Data
Feb. 21, 2008 (JP) 2008-040177

(51) Int. Cl. G01N 35/10; B01F 15/02

(52) U.S. Cl. 73/864.11; 366/131; 366/132

(57) ABSTRACT

A stirring device (1) capable of correctly detecting abnormality in a stirring process and preventing liquid which has not been stirred in a normal process from being used in an analyzing process, and an analyzer are provided. The stirring device (1) according to the present invention includes a nozzle (2), a syringe (14), and an abnormality detecting section (35) for determining whether or not a stirring process has been performed in a normal manner on liquid, which is a stirring subject, in a stirring container (23), on the basis of the amount of deviation between a suction pressure waveform indicating a suction pressure change measured by a pressure measuring section (6), and a suction pressure waveform pre-obtained during normal stirring.

### CROSS-REFERENCE TO RELATED APPLICATIONS

This application is a continuation of PCT international application Ser. No. PCT/JP2009/053086 filed on Feb. 20, 2009 which designates the United States, incorporated herein by reference, and which claims the benefit of priority from Japanese Patent Application No. 2008-040177, filed on Feb. 21, 2008, incorporated herein by reference.

### TECHNICAL FIELD

The present invention relates to a stirring device for repeatedly sucking and discharging liquid in a container to stir the liquid, and an analyzer.

### BACKGROUND ART

Analyzers for analyzing blood and bodily fluids are conventionally provided with a dispenser for dispensing a sample or a reagent into a reaction tube, the dispenser having a nozzle for sucking or discharging liquid using pressure transmitted from a syringe. In order to detect abnormal liquid suction of such a dispenser, a detection method is proposed for measuring pressure applied to a nozzle and comparing the rate of change in a measured value of the pressure with a predetermined threshold value to detect nozzle clogging (see Japanese Laid-Open Publication No. 2000-46846, for example).

### DISCLOSURE OF THE INVENTION

In an analyzer for analyzing blood and bodily fluids, a stirring device is used for repeatedly sucking and discharging liquid in a container to stir the liquid in the container. Such a stirring device is used, for example, as a pretreatment device for diluting a sample, such as a whole blood sample, with a diluent, and as a stirring mechanism for stirring liquid and a reagent in a reaction tube to accelerate the reaction. In addition, in order to increase the analyzing accuracy of the analyzer, it is necessary to perform a stirring process appropriately by the pretreatment device and the stirring mechanism. The reason is as follows. If a sample and a diluent are not stirred sufficiently in a container in a pretreatment device, the diluted sample cannot be dispensed accurately. Alternatively, if a sample and a reagent are not stirred sufficiently in a reaction tube in a stirring mechanism within an analyzer, the reaction will not progress appropriately between the sample and the reagent. Thus, in order to increase the analyzing accuracy in such an analyzer, it is necessary to detect whether or not a stirring process is performed in a normal manner in a stirring device.

In a conventional nozzle clogging detecting method, however, clogging can be detected only during liquid suction. As a result of this, in the conventional nozzle clogging detecting method, it is not possible to detect all the abnormalities in a stirring device, and further, it is not possible to detect either abnormal liquid suction due to a cause except for clogging at liquid suction, or abnormal liquid discharge. As such, since it has not been possible to accurately detect abnormal stirring of a stirring device, using the conventional nozzle clogging detecting method, there have been cases where samples which are not sufficiently diluted and reaction liquids which are not sufficiently accelerated for reaction are used in analyzing processes.

The present invention is intended to solve the defect of the conventional technique described above. The objective of the present invention is to provide: a stirring device capable of accurately detecting an abnormal stirring process and preventing liquid, which has not been stirred in a normal manner, from being used in an analyzing process; and an analyzer.

A stirring device according to the present invention for repeating suction and discharge of liquid in a container to stir the liquid includes: a nozzle for sucking or discharging the liquid; a pressure generating section for generating pressure necessary for the nozzle to suck or discharge the liquid; a pressure measuring section for measuring pressure generated by the pressure generating section and applied to the nozzle; and a determining section for determining whether or not a stirring process has been performed on the liquid in a normal manner, on the basis of an amount of deviation between a suction pressure waveform indicating a suction pressure change measured by the pressure measuring section, and a suction pressure waveform pre-obtained during normal stirring, thereby achieving the objective described above.

Further, in the stirring device according to the present invention, the determining section determines that the stirring process has been performed on the liquid in a normal manner when an integrated value of suction pressure measurement values within a predetermined period of time of the suction pressure waveform measured by the pressure measuring section is within a first tolerance range, which is set on the basis of an integrated value of pressure measurement values within the predetermined period of time of the suction pressure waveform pre-obtained during normal stirring; and determines that the stirring process has not been performed on the liquid in a normal manner when the integrated value of the suction pressure measurement values measured by the pressure measuring section has deviated out of the first tolerance range.

Still further, in the stirring device according to the present invention, the determining section determines that the stirring process has not been performed on the liquid in a normal manner due to an insufficient liquid amount or the nozzle not reaching a liquid surface, when the integrated value of the suction pressure measurement values measured by the pressure measuring section is more than an upper limit of the first tolerance range; and determines that the stirring process has not been performed on the liquid in a normal manner due to clogging in the nozzle, when the integrated value of the suction pressure measurement values measured by the pressure measuring section is less than a lower limit of the first tolerance range.

Still further, in the stirring device according to the present invention, a stirring device for repeating suction and discharge of liquid in a container to stir the liquid includes: a nozzle for sucking or discharging the liquid; a pressure generating section for generating pressure necessary for the nozzle to suck or discharge the liquid; a pressure measuring section for measuring pressure generated by the pressure generating section and applied to the nozzle; and a determining section for determining whether or not a stirring process has been performed on the liquid in a normal manner, on the basis of an amount of deviation between a discharge pressure waveform indicating a discharge pressure change measured by the pressure measuring section, and a discharge pressure waveform pre-obtained during normal stirring.

Still further, in the stirring device according to the present invention, the determining section determines that the stirring process has been performed on the liquid in a normal manner when an integrated value of discharge pressure measurement values within a predetermined period of time of the discharge pressure waveform measured by the pressure measuring section is within a second tolerance range, which is set on the basis of an integrated value of pressure measurement values within the predetermined period of time of the discharge pressure waveform pre-obtained during normal stirring; and determines that the stirring process has not been performed on the liquid in a normal manner when the integrated value of the discharge pressure measurement values measured by the pressure measuring section has deviated out of the second tolerance range.

Still further, in the stirring device according to the present invention, the determining section determines that the stirring process has not been performed on the liquid in a normal manner due to clogging in the nozzle, when the integrated value of the discharge pressure measurement values measured by the pressure measuring section is more than an upper limit of the second tolerance range; and determines that the stirring process has not been performed on the liquid in a normal manner due to an insufficient liquid amount or the nozzle not reaching a liquid surface, when the integrated value of the discharge pressure measurement values measured by the pressure measuring section is less than a lower limit of the second tolerance range.

Still further, in the stirring device according to the present invention, a stirring device for repeating suction and discharge of liquid in a container to stir the liquid includes: a nozzle for sucking or discharging the liquid; a pressure generating section for generating pressure necessary for the nozzle to suck or discharge the liquid; a pressure measuring section for measuring pressure generated by the pressure generating section and applied to the nozzle; and a determining section for determining whether or not a stirring process has been performed on the liquid in a normal manner, on the basis of an amount of deviation between a suction pressure waveform indicating a suction pressure change measured by the pressure measuring section, and a suction pressure waveform pre-obtained during normal stirring as well as an amount of deviation between a discharge pressure waveform indicating a discharge pressure change measured by the pressure measuring section, and a discharge pressure waveform pre-obtained during normal stirring.

Still further, in the stirring device according to the present invention, the determining section determines that the stirring process has been performed on the liquid in a normal manner when an integrated value of suction pressure measurement values within a predetermined period of time of the suction pressure waveform measured by the pressure measuring section is within a first tolerance range, which is set on the basis of an integrated value of pressure measurement values within the predetermined period of time of the suction pressure waveform pre-obtained during normal stirring, and when an integrated value of discharge pressure measurement values within a predetermined period of time of the discharge pressure waveform measured by the pressure measuring section is within a second tolerance range, which is set on the basis of an integrated value of pressure measurement values within the predetermined period of time of the discharge pressure waveform pre-obtained during normal stirring; and determines that the stirring process has not been performed on the liquid in a normal manner when the integrated value of the suction pressure measurement values measured by the pressure measuring section has deviated out of the first tolerance range and/or when the integrated value of the discharge pressure measurement values measured by the pressure measuring section has deviated out of the second tolerance range.

Still further, in the stirring device according to the present invention, the determining section determines that the stirring process has not been performed on the liquid in a normal manner due to an insufficient liquid amount, the nozzle not reaching a liquid surface, clogging in the nozzle or the nozzle contacting a bottom surface of the container, in accordance with each combination of: when the integrated value of the suction pressure measurement values measured by the pressure measuring section is more than the upper limit of the first tolerance range; or when the integrated value of the suction pressure measurement values measured by the pressure measuring section is less than the lower limit of the first tolerance range; as well as when the integrated value of the discharge pressure measurement values measured by the pressure measuring section is more than the upper limit of the second tolerance range; or when the integrated value of the discharge pressure measurement values measured by the pressure measuring section is less than the lower limit of the second tolerance range.

Still further, in the stirring device according to the present invention, the first tolerance range is set on the basis of the integrated value of pressure measurement values within the predetermined period of time of the suction pressure waveform pre-obtained during normal stirring, and dispensing accuracy of a dispensing device for dispensing the liquid stirred by the stirring device.

Still further, in the stirring device according to the present invention, the second tolerance range is set on the basis of the integrated value of pressure measurement values within the predetermined period of time of the discharge pressure waveform pre-obtained during normal stirring, and dispensing accuracy of a dispensing device for dispensing the liquid stirred by the stirring device.

Still further, in the stirring device according to the present invention, the pressure measuring section measures pressure applied to the nozzle for each suction process at the nozzle, and the determining section calculates an average value of integrated values of suction pressure measurement values at suction processes measured by the pressure measuring section, and compares the calculated average value of the integrated values with the first tolerance range to determine whether or not the stirring process has been performed on the liquid in a normal manner.

Still further, in the stirring device according to the present invention, the pressure measuring section measures pressure applied to the nozzle for each discharge process at the nozzle, and the determining section calculates an average value of integrated values of discharge pressure measurement values at discharge processes measured by the pressure measuring section, and compares the calculated average value of the integrated values with the second tolerance range to determine whether or not the stirring process has been performed on the liquid in a normal manner.

Still further, in the stirring device according to the present invention, the predetermined period of time is a period of time when a pressure waveform shape measured by the pressure measuring section is stabilized.

Still further, an analyzer according to the present invention includes any one of the above-described stirring device according to the present invention.

According to the present invention, in a stirring device for repeating suction and discharge of liquid in a container to stir the liquid, it is determined whether or not a stirring process has been performed in a normal manner on liquid in a container, which is a stirring subject, on the basis of at least one of the amount of deviation between a suction pressure waveform, indicating a measured suction pressure change, and a suction pressure waveform pre-obtained during normal stirring, or the amount of deviation between a discharge pressure waveform, indicating a discharge pressure change measured by a pressure measuring section, and a discharge pressure waveform pre-obtained during normal stirring. Thereby, it is possible to prevent liquid, which has not been stirred in a normal manner, from being used in an analyzing process.

### BRIEF DESCRIPTION OF THE DRAWINGS

FIG. 1 is a diagram schematically illustrating a structure of a stirring device according to Embodiment 1.

FIG. 2 is a diagram illustrating time dependence between suction pressure of normal stirring and suction pressure of abnormal stirring.

FIG. 3 is a diagram illustrating time dependence between suction pressure of normal stirring and suction pressure of abnormal stirring.

FIG. 4 is a diagram describing an abnormality determining process of a stirring process of the stirring device illustrated in FIG. 1.

FIG. 5 is a flowchart illustrating process steps of a stirring process of the stirring device illustrated in FIG. 1.

FIG. 6 is a flowchart illustrating process steps of an abnormal stirring detecting process illustrated in FIG. 5.

FIG. 7 is a diagram illustrating time dependence between suction pressure of normal stirring and suction pressure of abnormal stirring.

FIG. 8 is a diagram describing an abnormality determining process of a stirring process of the stirring device illustrated in FIG. 1.

FIG. 9 is a diagram schematically illustrating a structure of a stirring device according to Embodiment 2.

FIG. 10 is a diagram illustrating time dependence between discharge pressure of normal stirring and discharge pressure of abnormal stirring.

FIG. 11 is a diagram illustrating time dependence between discharge pressure of normal stirring and discharge pressure of abnormal stirring.

FIG. 12 is a diagram describing an abnormality determining process of a stirring process of the stirring device illustrated in FIG. 9.

FIG. 13 is a flowchart illustrating process steps of a stirring process illustrated in FIG. 9.

FIG. 14 is a flowchart illustrating process steps of an abnormal stirring detecting process illustrated in FIG. 13.

FIG. 15 is a diagram illustrating time dependence between discharge pressure of normal stirring and discharge pressure of abnormal stirring.

FIG. 16 is a diagram describing an abnormality determining process of a stirring process of the stirring device illustrated in FIG. 9.

FIG. 17 is a diagram schematically illustrating a structure of a stirring device according to Embodiment 3.

FIG. 18 is a flowchart illustrating process steps of a stirring process illustrated in FIG. 17.

FIG. 19 is a flowchart illustrating process steps of an abnormal stirring detecting process illustrated in FIG. 18.

FIG. 20 is a diagram exemplifying a determination table referred to by an abnormality detecting section illustrated in FIG. 17.

FIG. 21 is a schematic perspective view illustrating an exemplary internal structure of an analyzer applied with a stirring device according to an embodiment.

1, 201, 301 stirring device
2 nozzle
3 nozzle transferring section
4 syringe
4a cylinder
4b piston
5 tube
6 pressure measuring section
7 piston driving section
8 tube
9 electromagnetic valve
10 pump
11 cleaning liquid tank
12 nozzle
14 syringe
14a cylinder
14b piston
15 tube
17 piston driving section
18 tube
19 electromagnetic valve
20 pump
21 diluent tank
22 container
23 stirring container
30 controlling section
34 input section
35, 235, 335 abnormality detecting section
36 storing section
37 output section
61 pressure sensor
62 signal processing circuit
401 analyzer
404 controlling section
411 sample rack conveying section
415 sample dispensing section
417 diluted sample rack conveying section
419 diluted sample rack
421 diluent dispensing section
423 diluted sample dispensing section
425 plate conveying section
427 microplate
429 reagent dispensing section
431 reagent storing section
433 measuring section
435 plate collecting section
441 analyzing section
443 input section
445 output section
4111 rack feeder
4271 reaction container
4311 reagent container
4331 image capturing section
4333 light source
La diluent
Sa sample
Sb liquid
Wa cleaning liquid

### BEST MODE FOR CARRYING OUT THE INVENTION

Hereinafter, embodiments of the present invention will be described, with reference to accompanying figures, with an example of a stirring device functioning as a pretreatment device of an analyzer, for diluting a sample, such as blood or urine, and a diluent. It is noted that the present invention is not limited to the embodiments. It is also note that corresponding portions of the figures are given the same reference numerals.

### Embodiment 1

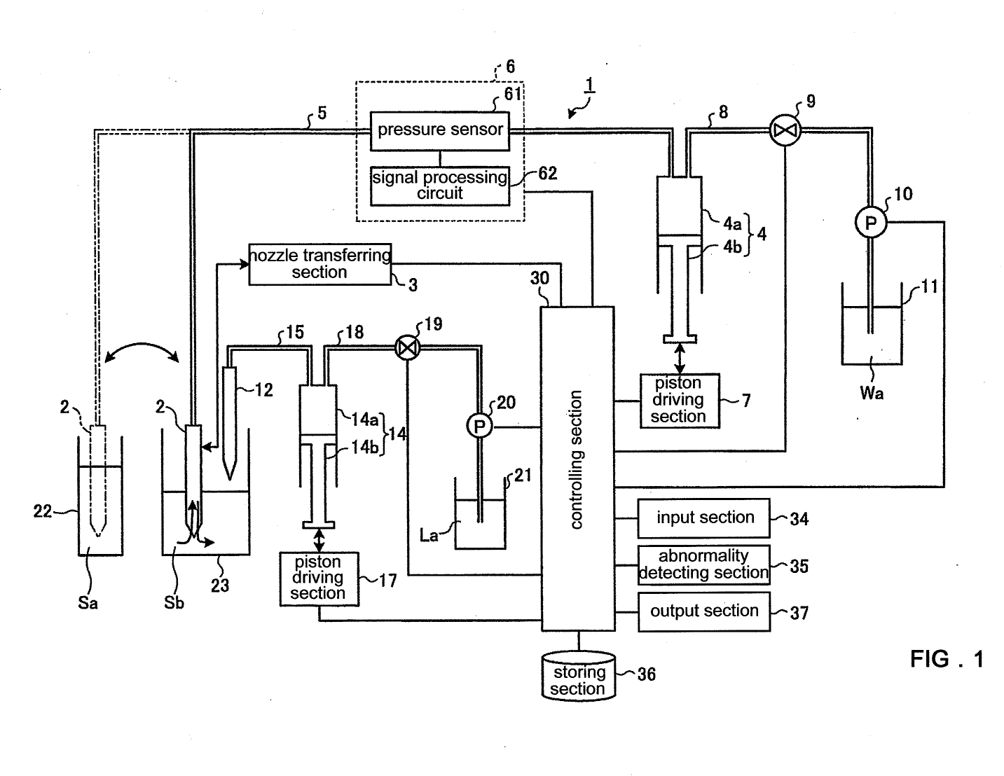

First, Embodiment 1 will be described. FIG. 1 is a diagram schematically illustrating a structure of a stirring device according to Embodiment 1. A stirring device 1 illustrated in FIG. 1 includes: a tubular nozzle 2 for sucking and discharging a liquid Sb in a stirring container 23, the liquid being a stirring subject; a nozzle transferring section 3 for transferring the nozzle 2 by performing raising and lowering operations on the nozzle 2 in a vertical direction and a rotating operation on the nozzle 2 in a horizontal direction; a syringe 4 for performing sucking and discharging operations of a cleaning liquid Wa, functioning as a pressure transmitting medium for transmitting pressure to the nozzle 2; a tube 5 for connecting the nozzle 2 and the syringe 4 to create a flowing pathway of the cleaning liquid Wa; and a pressure measuring section 6 for detecting pressure applied to the nozzle 2. The cleaning liquid Wa is an incompressible fluid, such as ion exchanged water or distilled water.

The nozzle 2, nozzle transferring section 3, syringe 4 and tube 5 repeat sucking and discharging of a sample in the stirring container 23, the sample being the liquid of a stirring subject, and a diluent to stir the liquid in the stirring container 23, and also dispense a predetermined amount of a sample Sa from a container 22, in which the sample Sa is contained, into the stirring container 23, where the sample Sa includes a whole blood sample, urine or the like, and is a diluting subject.

The stirring device 1 further includes: a tubular nozzle 12 for injecting a diluent La into the stirring container 23; a nozzle transferring section (not shown) for transferring the nozzle 12 by performing raising and lowering operations on the nozzle 12 in a vertical direction and a rotating operation on the nozzle 2 in a horizontal direction; a syringe 14 for performing sucking and discharging operations of the diluent La; and a tube 15 for connecting the nozzle 12 and the syringe 14 to create a flowing pathway of the diluent La. The diluent La is ion exchanged water or the like. The nozzle 12, syringe 14 and tube 15 dispense a predetermined amount of the diluent La for diluting sample Sa, from a diluent tank 21 into the stirring container 23.

The syringe 4 includes a cylinder 4a and a piston 4b, and the piston 4b slides inside the cylinder 4a by a piston driving section 7 in vertical upward and downward directions in FIG. 1, thereby generating pressure to be transmitted to the nozzle 2 via the cleaning liquid Wa. The syringe 4 achieves part of functions of a pressure generating section for generating pressure necessary for the nozzle 2 to suck or discharge the liquid inside the stirring container 23. The syringe 4 is also connected to a tube 8, other than the tube 5. The other end of the tube 8 reaches a cleaning liquid tank 11 which contains the cleaning liquid Wa. In addition, the tube 8 is provided with an electromagnetic valve 9 for adjusting a flow rate of the cleaning liquid Wa and a pump 10 for performing sucking and discharging operations of the cleaning liquid Wa. When the electromagnetic valve 9 is opened, the cleaning liquid Wa sucked up by the pump 10 is supplied into the cylinder 4a.

The pressure measuring section 6 includes: a pressure sensor 61, connected with the tube 5, for detecting a pressure change of the cleaning liquid Wa filling the tube 5 to convert it into an electric signal; and a signal processing circuit 62 for performing signal processing, such as amplification and A/D conversion, to the electric signal output from the pressure sensor 61. Thereby the pressure measuring section 6 measures pressure applied to the nozzle 2. It is more preferable to dispose the pressure measuring section 6 near the nozzle 2; however, depending on conditions such as the sensitivity of the pressure sensor 61, the pressure measuring section 6 may be disposed in a middle portion of the nozzle 2 and the syringe 4, or may be disposed near the syringe 4.

In addition, the syringe 14 includes a cylinder 14a and a piston 14b. The syringe 14 is also connected to a tube 18, other than the tube 15. The other end of the tube 18 reaches a diluent tank 21 which contains the diluent La. In addition, the tube 18 is provided with an electromagnetic valve 19 for adjusting a flow rate of the diluent La and a pump 20 for performing sucking and discharging operations of the diluent La. When the electromagnetic valve 19 is opened, the diluent La sucked up by the pump 20 is supplied into the cylinder 14a. In addition, the piston 14b slides inside the cylinder 14a by a piston driving section 17 in vertical upward and downward directions in FIG. 1, thereby a predetermined amount of the diluent La from the syringe 14 is injected through the nozzle 12 into the stirring container 23.

The stirring device 1 further includes: a controlling section 30 for controlling a motion process of elements constituting the stirring device 1; an input section 34 for inputting various information; an abnormality detecting section 35 for detecting an abnormality in a stirring process in the stirring device 1; a storing section 36 for storing various information used for an abnormality detecting process by the abnormality detecting section 35; and an output section 37 for outputting various information.

The abnormality detecting section 35 detects whether or not a stirring process is performed in a normal manner on the liquid Sb in the stirring container 23, on the basis of the amount of deviation between a suction pressure waveform pre-obtained during normal stirring and a suction pressure waveform, measured by the pressure measuring section 6, indicating a suction pressure change.

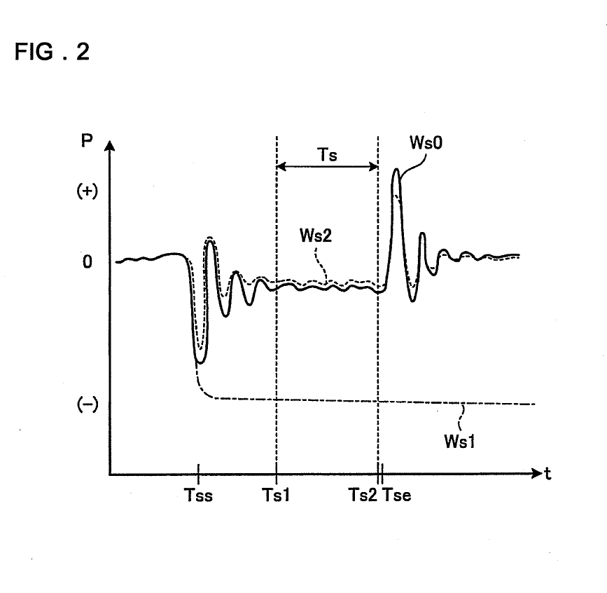

With reference to FIG. 2, a suction pressure waveform of normal stirring and a suction pressure waveform of abnormal stirring will be specifically described. FIG. 2 is a diagram illustrating time dependence between suction pressure of normal stirring and suction pressure of abnormal stirring. In FIG. 2, the number 0 in the axis of ordinates approximately represents atmospheric pressure. A waveform Ws0 in FIG. 2 represents the suction pressure waveform of normal stirring. Further, a waveform Ws1 represents a suction pressure waveform of abnormal stirring resulting from the occurrence of clogging by fibrin or the like in the nozzle 2. Still further, a waveform Ws2 represents a suction pressure waveform of abnormal stirring resulting from the insufficient amount of liquid of a stirring subject, or the nozzle 2 not reaching a liquid surface. In addition, the piston 4b starts sliding in the downward direction at a time Tss to start the suction of the liquid. Subsequently, the piston 4b stops sliding in the downward direction at a time Tse to end the suction of the liquid.

As represented by the waveform Ws0 in FIG. 2, during normal stirring, the pressure waveform is represented with the amplitude becoming gradually smaller with the elapse of suction. On the contrary, when the nozzle 2 is clogged as represented by the waveform Ws1 of abnormal stirring in FIG. 2 resulting from the occurrence of clogging in the nozzle 2, the suction pressure is rapidly decreased immediately after the start of the suction, and a saturated condition continues at a value with high negative pressure (lower than atmospheric pressure but the absolute value is high). In addition, when the amount of liquid of a stirring subject is not sufficient as represented by a waveform Ws2 of abnormal stirring resulting from the insufficient amount of the liquid or the nozzle 2 not reaching a liquid surface, the suction pressure value is indicated by a value with a lower negative pressure (with a smaller absolute value) compared to the case of normal stirring because the nozzle 2 cannot suck a predetermined amount of the liquid.

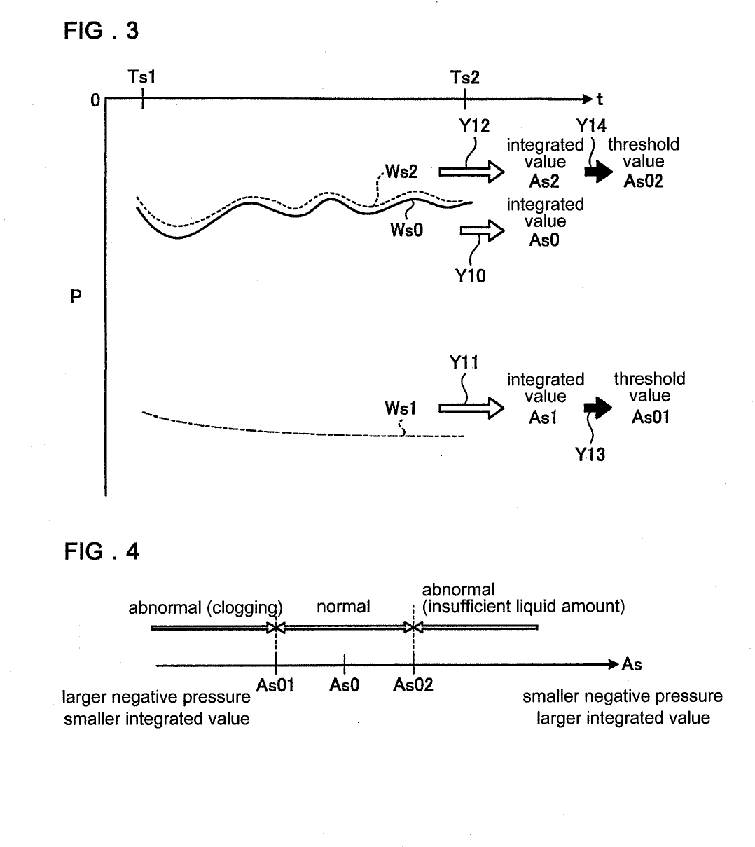

Next, FIG. 3 illustrates each of the waveforms within a predetermined period of time Ts, from a time Ts1 to a time Ts2, when each of the pressure waveforms is stabilized. As illustrated in FIG. 3, the waveform Ws1 of abnormal stirring resulting from the occurrence of clogging in the nozzle 2 continues to represent a value with constantly higher negative pressure than the waveform Ws0 of normal stirring. As a result, an integrated value As1 with respect to the waveform Ws1, represented by an arrow Y11, is remarkably smaller (where the absolute value becomes greater) than an integrated value As0 with respect to the waveform Ws0 of normal stirring, represented by an arrow Y10. Thus, when the nozzle 2 is clogged, the integrated value As1 of suction pressure values during the predetermined period of time Ts constantly becomes smaller than the integrated value As0 of normal stirring.

As described above, in the stirring device 1, it is determined whether or not there is an abnormality in the stirring process by making use of the fact that when the nozzle 2 is clogged, the integrated value of suction pressure values during the predetermined period of time Ts becomes remarkably smaller than the integrated value As0 with respect to the waveform Ws0 of normal stirring.

More specifically, the stirring device 1 sets a predetermined threshold value As01 as represented by an arrow Y13 on the basis of the integrated value As0 of normal stirring and the integrated value As1 of abnormal stirring resulting from the occurrence of clogging in the nozzle 2, and determines abnormal stirring due to the occurrence of clogging in the nozzle 2, using the threshold value As01. The threshold value As01 is set on the basis of the integrated value of pressure measurement values within the predetermined period of time Ts of the suction pressure waveform pre-obtained during normal stirring. The integrated value of pressure measurement values during the predetermined period of time Ts of the pre-obtained suction pressure waveform of normal stirring, is obtained as follows: in a normal condition, a stirring process is performed for a set number of times, and the integrated value of pressure measurement values during the predetermined period of time Ts is obtained for each stirring process; and the average of the integrated values is calculated. In addition, since it is necessary for an accurate amount of each of a diluent and a stirred sample to be dispensed by the stirring device 1, the threshold value As01 is determined on the basis of dispensing accuracy of a dispensing mechanism for dispensing a predetermined amount of liquid, which is stirred by the stirring device 1, for an analyzing process. For example, the threshold value As01 is a value obtained by subtracting 20% from the average value of the integrated values As0 of respective pressure measurement values of normal stirring.

Therefore, as illustrated in FIG. 4, when the integrated value of suction pressure values is less than the threshold value As01 during the predetermined period of time Ts, during which each pressure waveform is stabilized, it can be determined that the nozzle 2 is clogged and the stirring process has not been performed in a normal manner.

Further, as illustrated in FIG. 3, inmost of the cases, the waveform Ws2 of abnormal stirring, which is resulting from the insufficient amount of liquid or the nozzle 2 not reaching the liquid surface, continues to represent a value with low negative pressure compared to the waveform Ws0 of normal stirring. Therefore, an integrated value As2 with respect to the waveform Ws2 represented by the arrow Y12 is greater (where the absolute value is smaller) than the integrated value As0 with respect to the waveform Ws0 of normal stirring. Thus, in the case where the amount of liquid of a stirring subject is not sufficient or the nozzle 2 does not reach the liquid surface, the integrated value As2 of suction pressure values during the predetermined period of time Ts becomes greater than the integrated value As0 with respect to the waveform Ws0 of normal stirring.

As described above, in the stirring device 1, it is determined whether or not there is an abnormality in the stirring process by making use of the fact that when the amount of liquid of a stirring subject is not sufficient or the nozzle 2 does not reach the liquid surface, the integrated value of suction pressure values during the predetermined period of time Ts becomes greater than the integrated value As0 with respect to the waveform Ws0 of normal stirring. More specifically, the stirring device 1 sets a predetermined threshold value As02 as represented by an arrow Y14 on the basis of the integrated value As0 of normal stirring and the integrated value As2 of abnormal stirring resulting from the insufficient amount of liquid or the nozzle 2 not reaching the liquid surface, and determines abnormal stirring due to the insufficient amount of liquid or the nozzle 2 not reaching the liquid surface, using the threshold value As02. The threshold value As02 is set on the basis of the integrated value of pressure measurement values within the predetermined period of time Ts of the suction pressure waveform pre-obtained during normal stirring. In addition, since it is necessary for an accurate amount of each of a diluent and a stirred sample to be dispensed by the stirring device 1, the threshold value As02 is determined on the basis of dispensing accuracy of a dispensing mechanism for dispensing a predetermined amount of liquid, which is stirred by the stirring device 1, for an analyzing process. For example, the threshold value As02 is a value obtained by adding 20% to the average value of the integrated values As0 of respective pressure measurement values of normal stirring.

Therefore, as illustrated in FIG. 4, when the integrated value of suction pressure values is more than the threshold value As02 during the predetermined period of time Ts, during which each pressure waveform is stabilized, it can be determined that the amount of the liquid is not sufficient or the nozzle 2 does not reach the liquid surface and the stirring process has not been performed in a normal manner.

That is, as illustrated in FIG. 4, when the integrated value of suction pressure values is within the range from the threshold value As02 to the threshold value As01 during the predetermined period of time Ts, during which each pressure waveform is stabilized, that is, when the integrated value is within the range of the upper limit of the threshold value As02 and the lower limit of the threshold value As01, it can be determined that the stirring process is performed in a normal manner in the stirring device 1. In addition, when the integrated value of suction pressure values is less than the threshold value As01, it can be determined that the nozzle 2 is clogged and the stirring process has not been performed in a normal manner. Further, when the integrated value of suction pressure values is more than the threshold value As02, it can be determined that the amount of liquid is not sufficient or the nozzle 2 does not reach the liquid surface, resulting in an abnormal stirring process.

As described above, in the stirring device 1, the presence of abnormality in the stirring process and the cause of the abnormal stirring are determined on the basis of the integrated value As0 of normal stirring and tolerance between the threshold value As02 and the threshold value As01, which is set on the basis of dispensing accuracy of a dispensing device for dispensing a predetermined amount of liquid stirred by the stirring device 1. In addition, it is noted that the storing section 36 stores the threshold value As01 and the threshold value As02.

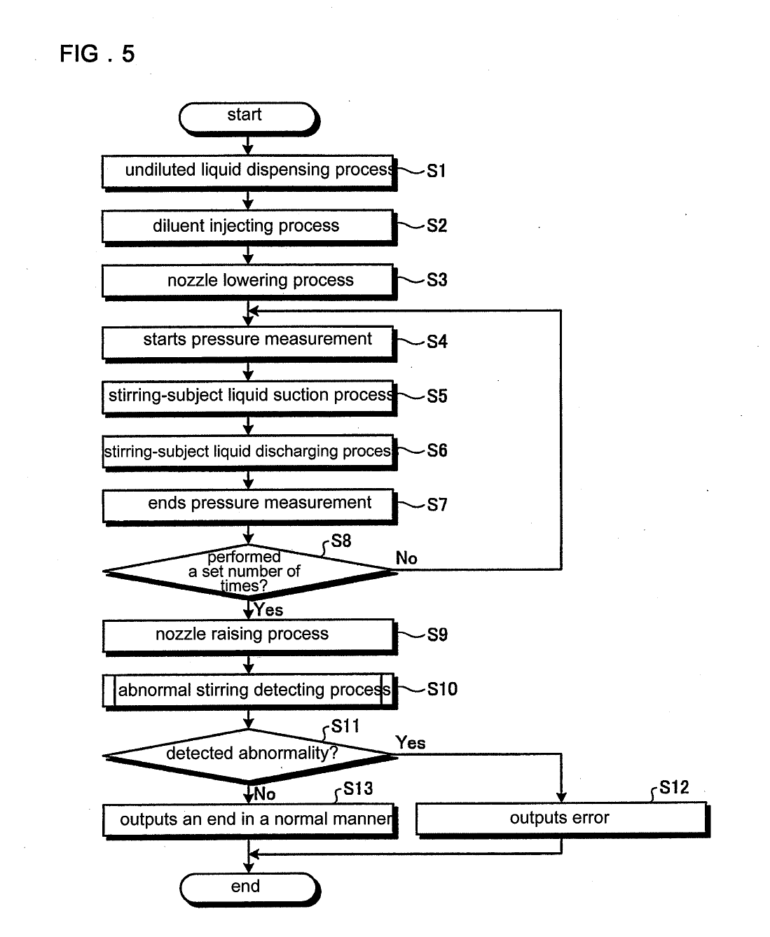

Next, the stirring process in the stirring device 1 will be described with reference to FIG. 5. As illustrated in FIG. 5, in the stirring device 1, under a transferring process of the nozzle 2 by the nozzle transferring section 3 and a driving process of the piston 4b by the piston driving section 7, the nozzle 2 performs a undiluted liquid dispensing process for dispensing a predetermined amount of the sample Sa, the undiluted liquid, from the container 22 into the stirring container 23 (step S1). Next, under a driving process of the piston 14b by the piston driving section 17, the nozzle 12 performs a diluent injecting process for injecting a predetermined amount of the diluent La from the diluent tank 21 into the stirring container 23 (step S2). Subsequently, the nozzle transferring section 3 performs a nozzle lowering process for lowering the nozzle 2 into the stirring container 23 (step S3).

After the nozzle 2 is inserted into the stirring container by the nozzle transferring section 3, the pressure measuring section 6 starts a pressure measuring process for measuring pressure applied to the nozzle 2 (step S4). Pressure measurement values measured by the pressure measuring section 6 are output to the abnormality detecting section 35 via the controlling section 30.

Next, the piston driving section 7 slides the piston 4b in a vertical downward direction, so that the nozzle 2 performs a stirring-subject liquid suction process for sucking stirring-subject liquid in the stirring container 23 (step S5). Further, the piston driving section 7 slides the piston 4b in a vertical upward direction, so that the nozzle 2 performs a stirring-subject liquid discharging process for discharging the sucked stirring-subject liquid into the stirring container 23 (step S6). When the stirring-subject liquid discharging process ends, the pressure measuring section 6 ends pressure measurement (step S7).

The controlling section 30 determines whether or not the stirring-subject liquid suction process (step S5) and stirring-subject liquid discharging process (step S6) are performed for a set number of times (step S8). If the controlling section 30 determines that the processes have not been performed for a set number of times (step S8: No), the process goes back to the step S4 to perform the stirring-subject liquid suction process (step S5) and stirring-subject liquid discharging process (step S6) for a set number of times, and the pressure measurement starting process (step S4), stirring-subject liquid suction process (step S5) and stirring-subject liquid discharging process (step S6) are performed.

On the other hand, if the controlling section 30 determines that the stirring-subject liquid suction process (step S5) and stirring-subject liquid discharging process (step S6) have been performed a set number of times (step S8: Yes), in order to end the stirring process, the nozzle transferring section 3 performs a nozzle raising process for raising the nozzle 2 from the stirring container 23 (step S9).

Next, the abnormality detecting section 35 compares an integrated value of pressure measurement values of suction, among pressure values added to the nozzle 2 measured by the pressure measuring section 6, with each of threshold values stored in the storing section 36 to perform an abnormal stirring detecting process for detecting the presence of abnormality in the stirring process and a cause of abnormal stirring (step S10).

Next, the controlling section 30 determines whether or not abnormality in the stirring process is detected by the abnormality detecting section 35 (step S11). If the controlling section 30 determines that abnormality is detected in the stirring process by the abnormality detecting section 35 (step S11: Yes), the controlling section 30 allows the output section 37 to output the fact that there is abnormality in the subject stirring process as well as an error message indicating the cause of the abnormality in the stirring process (step S12). On the other hand, if the controlling section 30 determines that no abnormality is an detected in the stirring process by the abnormality detecting section 35 (step S11: No), the controlling section 30 allows the output section 37 to output an message indicating that the subject stirring process has ended in a normal manner (step S13).

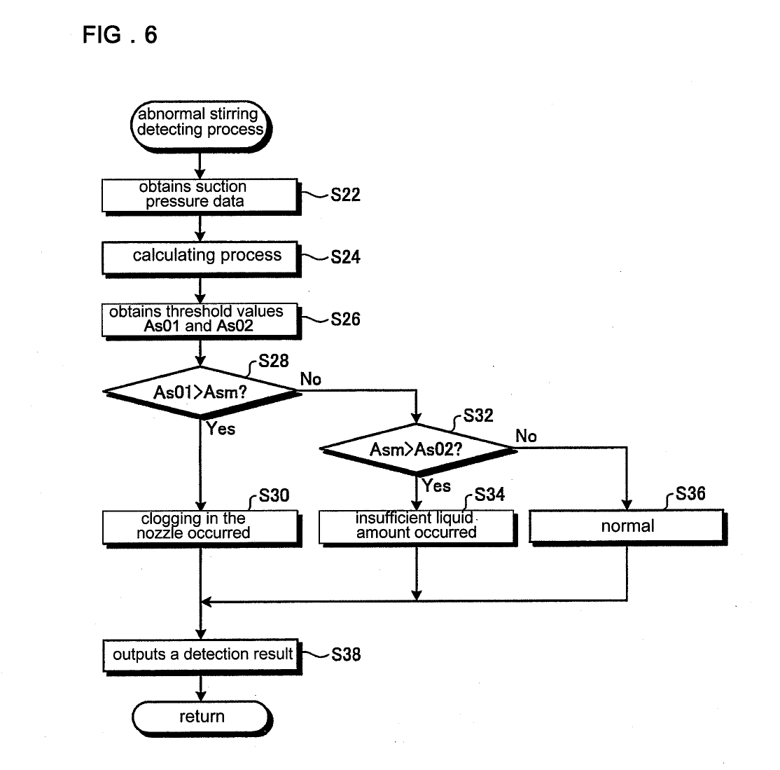

Next, the abnormal stirring detecting process illustrated in FIG. 5 will be described with reference to FIG. 6. As illustrated in FIG. 6, the abnormality detecting section 35 obtains suction pressure data, which represents a pressure measurement value of suction, among pressure measurement values measured by the pressure measuring section 6 (step S22). Subsequently, the abnormality detecting section 35 performs a calculating process for integrating pressure measurement values within the predetermined period of time Ts for every set of stirring-subject liquid suction processes performed a set number of times to calculate an average value Asm of the integrated values (step S24). Next, the abnormality detecting section 35 obtains threshold values As01 and As02 from the storing section 36 (step S26). The abnormality detecting section 35 detects the presence of an abnormality in the stirring process and a cause of abnormal stirring by comparing the calculated average value Asm of the integrated values and the obtained threshold values As01 and As02.

First, the abnormality detecting section 35 compares the threshold value As01, which is the upper limit of the above-described tolerance, and the calculated average value Asm of the integrated values to determine whether As01>Asm holds (step S28). If the abnormality detecting section 35 determines that As01>Asm (step S28: Yes), that is, if the average value Asm of the integrated values of actual suction pressure measurement values in the nozzle 2 is less than the threshold value As01 and has deviated out of the tolerance, the threshold value being the lower limit of the tolerance and being a reference for determining the occurrence of clogging in the nozzle 2, it is determined that the subject stirring process has not been performed in a normal manner due to clogging in the nozzle 2 (step S30).

On the other hand, if the abnormality detecting section 35 determines that As01>Asm does not hold (step S28: No), that is, if the average value Asm of the integrated values of actual suction pressure measurement values in the nozzle 2 is equal to or greater than the threshold value As01, the threshold value being the lower limit of the tolerance and being a reference for determining the occurrence of clogging in the nozzle 2, the abnormality detecting section 35 compares the threshold value As02, which is the upper limit of the above-described tolerance, and the calculated average value Asm of the integrated values to determine whether or not Asm>As02 holds (step S32).

If the abnormality detecting section 35 determines that Asm>As02 holds (step S32: Yes), that is, if the average value Asm of the integrated values of actual suction pressure measurement values in the nozzle 2 is more than the threshold As02 and has deviated out of the tolerance, the threshold being a reference for determining the occurrence of the insufficient liquid amount or the nozzle 2 not reaching the liquid surface and being the upper limit of the tolerance, it is determined that the subject stirring process has not been performed in a normal manner due to the insufficient liquid amount or the nozzle 2 not reaching the liquid surface (step S34). In this case, abnormality in the transfer controlling of the nozzle transferring section 3 for transferring the nozzle 2, insufficient dispensing amount of the sample Sa by the nozzle 2, or insufficient injecting amount of the diluent La by the nozzle 12 is conceivable.

On the other hand, if the abnormality detecting section 35 determines that Asm>As02 does not hold (step S32: No), since such a case occurs when the average value Asm of the integrated values of actual suction pressure measurement values in the nozzle 2 is within a reference range, it is determined that the stirring process has been performed in a normal manner (step S36). Subsequently, the abnormality detecting section 35 outputs a detection result (step S38), and ends the abnormal stirring detecting process.

As described above, the stirring device 1 according to Embodiment 1 determines whether or not the stirring process has been performed in a normal manner on liquid of a stirring subject in the container, on the basis of the amount of deviation between a suction pressure waveform measured by the pressure measuring section 6 and the suction pressure waveform pre-obtained during normal stirring. Thereby, it becomes possible to prevent liquid that is not stirred in a normal manner from being used in an analyzing process, and reduce the waste of reagents and analyzing time in the analyzing process.

In addition, the stirring device 1 determines whether or not the integrated value of suction pressure measurement values within the predetermined period of time Ts of the suction pressure waveform measured by the pressure measuring section 6, is within the tolerance range set on the basis of the integrated value of pressure measurement values within the predetermined period of time Ts of the suction pressure waveform pre-obtained during normal stirring. In other words, the stirring device 1 determines whether there is abnormality in the stirring process using a value obtained by integrating timewise the amount of deviation from the suction pressure waveform of normal stirring of the suction pressure waveform measured by the pressure measuring section 6; and there are a plurality of pressure measurement values to be integrated. Thereby, a more reliable determination can be made as to whether or not there is an abnormality in the stirring process, compared to the case where the determination is made using the amount of deviation at only one point. In addition, in the stirring device 1, the abnormality detecting process is performed on the basis of, not a pressure measurement value within an unstable state, but an integrated value of pressure measurement values within a period when the suction pressure waveform is stabilized. Thereby, it becomes possible to reduce an influence of deviation in pressure measurement values in an unstable state to perform detecting of abnormality in a stirring process accurately. Further, in the stirring device 1, each integrated value of pressure measurement values is calculated for each plurality of suction processes and the abnormality detecting process is performed using the average value of the plurality of integrated values, so that there is a larger number of monitored points and measured suction pressure values to be averaged, compared to the case where the determination is made using an integrated value of pressure measurement values of only one suction process, thereby performing a reliable determination of whether or not there is an abnormality in a stirring process.

Further, according to Embodiment 1, it is possible to detect, not only the existence of a simple abnormality in a stirring process, but also the cause of the abnormality in the stirring process. Accordingly, a maintenance worker of the stirring device 1 can recognize with which mechanism a cause of abnormality in the stirring process is associated, thereby handling the abnormality in the stirring process of the stirring device quickly and accurately.

Typically, when different liquids of a stirring subject have the same amount and viscosity, a suction pressure waveform will be substantially the same every time during a stirring process performed in a normal manner. Therefore, the stirring device 1 may determine the existence of abnormal stirring on the basis of each tolerance range in accordance with each amount and viscosity of liquid to be a stirring subject. More specifically, the stirring device 1 may perform stirring processes in advance with different amounts and viscosities of liquid, and obtain an integrated value of suction pressure values within a predetermined period of time of a suction pressure waveform in the stirring processes, and the stirring device 1 may set, on the basis of respective integrated values or the like, a threshold value As01, which is the lower limit of a tolerance range, and a threshold value As02, which is the upper limit of a tolerance range, corresponding to each amount and each viscosity of liquid.

In addition, according to Embodiment 1, it is also possible to provide a threshold value corresponding to each of the insufficient liquid amount and the nozzle 2 not reaching the liquid surface, to determine in detail which of the insufficient liquid amount or the nozzle 2 not reaching the liquid surface has caused an abnormal stirring process.

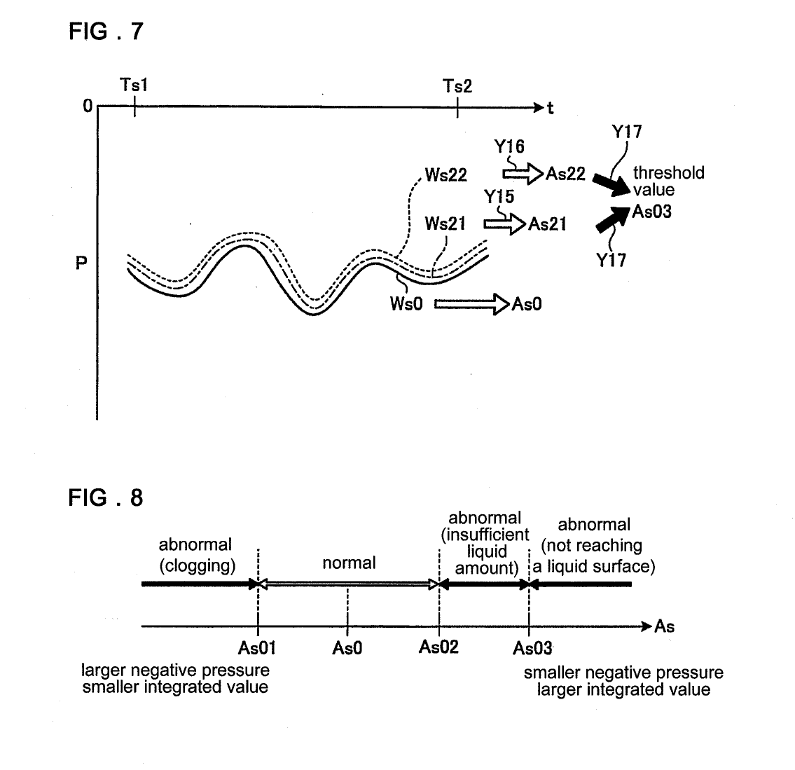

FIG. 7 illustrates a waveform Ws0 representing a suction pressure waveform of normal stirring as well as a waveform Ws21 representing a suction pressure waveform of abnormal stirring resulting from an insufficient liquid amount, and a waveform Ws22 representing a suction pressure waveform of abnormal stirring resulting from the nozzle 2 not reaching a liquid surface. As represented by the waveform Ws21 in FIG. 7, each suction pressure value at an insufficient liquid amount indicates a value with a lower negative pressure compared to the waveform Ws0 at normal stirring because the amount of sucked liquid is less than a predetermined amount. Further, as represented by the waveform Ws22 in FIG. 7, each suction pressure value in the case of the nozzle 2 not reaching a liquid surface indicates a value with a still lower negative pressure, compared to the waveform Ws21 in the case of an insufficient liquid amount, because the liquid cannot be sucked. As described above, a certain tendency can be recognized in a value distribution of respective suction pressure values in the case of an insufficient liquid amount and the case of the nozzle 2 not reaching a liquid surface. In the stirring device 1, this tendency is used and a threshold value is set, which allows to distinguish the case of an insufficient liquid amount from the case of the nozzle 2 not reaching a liquid surface, in addition to the threshold value As02, which allows to distinguish whether or not it is normal stirring, to determine which is the cause of the abnormal stirring process, the insufficient liquid amount or the nozzle 2 not reaching a liquid surface.

More specifically, a threshold value As03 may be set, which allows to distinguish the case of the insufficient liquid amount from the case of the nozzle 2 not reaching a liquid surface, as represented by an arrow Y17, on the basis of an average value As21 of integrated values of suction pressure values within the predetermined period of time Ts in the waveform Ws21 at an insufficient liquid amount represented by an arrow Y15, and an average value As22 of integrated values of suction pressure values within the predetermined period of time Ts in the waveform Ws22 in the case of the nozzle 2 not reaching a liquid surface represented by an arrow Y16.

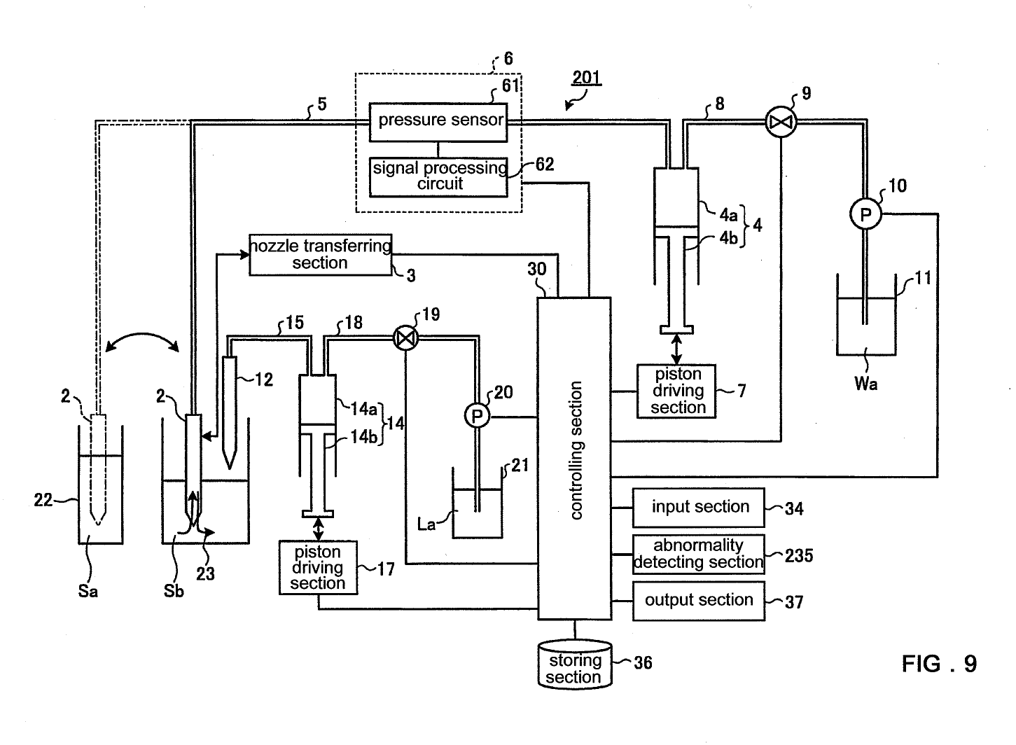

Therefore, as illustrated in FIG. 8, the abnormality detecting section 35 determines that a stirring process has not been performed in a normal manner due to an insufficient liquid amount in a case where an integrated value of suction pressure values is more than the threshold value As02 and is equal to or less than the threshold value As03 within a predetermined period of time Ts, during which pressure waveforms are stabilized. In addition, the abnormality detecting section 35 determines that a stirring process has not been performed in a normal manner due to the nozzle 2 not reaching a liquid surface in a case where an integrated value of suction pressure values is more than the threshold value As02 and is still more than the threshold value As03 within a predetermined period of time Ts, during which pressure waveforms are stabilized. As described above, by further providing the threshold value As03, the stirring device 1 may determine in detail which is the cause of an abnormal stirring process, the insufficient liquid amount or the nozzle 2 not reaching a liquid surface.

### Embodiment 2

Next, Embodiment 2 will be described. In Embodiment 2, a case will be described for detecting abnormality in a stirring process on the basis of a pressure waveform at liquid discharging in the stirring process. FIG. 9 is a diagram schematically illustrating a structure of a stirring device according to Embodiment 2. As illustrated in FIG. 9, a stirring device 201 according to Embodiment 2 includes an abnormality detecting section 235 instead of the abnormality detecting section 35 illustrated in FIG. 1.

The abnormality detecting section 235 determines whether or not a stirring process has been performed in a normal manner with respect to liquid Sb in a stirring container 23, on the basis of the amount of deviation between a discharge pressure waveform representing a discharge pressure change measured by a pressure measuring section 6 and a discharge pressure waveform pre-obtained during normal stirring.

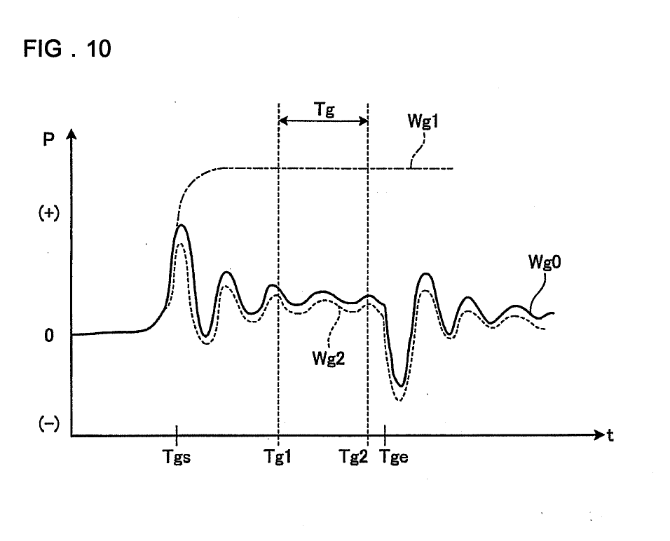

A discharge pressure waveform of normal stirring and a discharge pressure waveform of abnormal stirring will be specifically described with reference to FIG. 10. FIG. 10 is a diagram illustrating time dependence between a discharge pressure of normal stirring and a discharge pressure of abnormal stirring. In FIG. 10, a waveform Wg0 represents a discharge pressure waveform at normal stirring; and a waveform Wg2 represents a discharge pressure waveform of abnormal stirring resulting from an insufficient amount of liquid of a stirring subject or a nozzle 2 not reaching a liquid surface. In addition, at a time Tgs, sliding of a piston 4b starts in an upward direction and liquid starts to be discharged. Subsequently, at a time Tge, the sliding of the piston 4b in the upward direction is stopped and the discharge of the liquid ends.

As represented by the waveform Wg0 in FIG. 10, during normal stirring, a pressure waveform is represented with the amplitude becoming gradually smaller with the elapse of discharge. On the contrary, as represented by a waveform Wg1 of abnormal stirring in FIG. 10 resulting from the occurrence of clogging in a nozzle 2, when the nozzle 2 is clogged, discharge pressure resulting from the clogging and is rapidly increased immediately after the start of discharging, and a saturated state with a large value is attained. In addition, if the amount of liquid of a stirring subject is not sufficient, the nozzle 2 will not be able to discharge a predetermined amount of liquid and the liquid of a discharging subject will be in a state where it does not exist in the nozzle 2 either from the beginning or at midway. Thus, a discharge pressure value will represent a state with a lower pressure compared to a normal state.

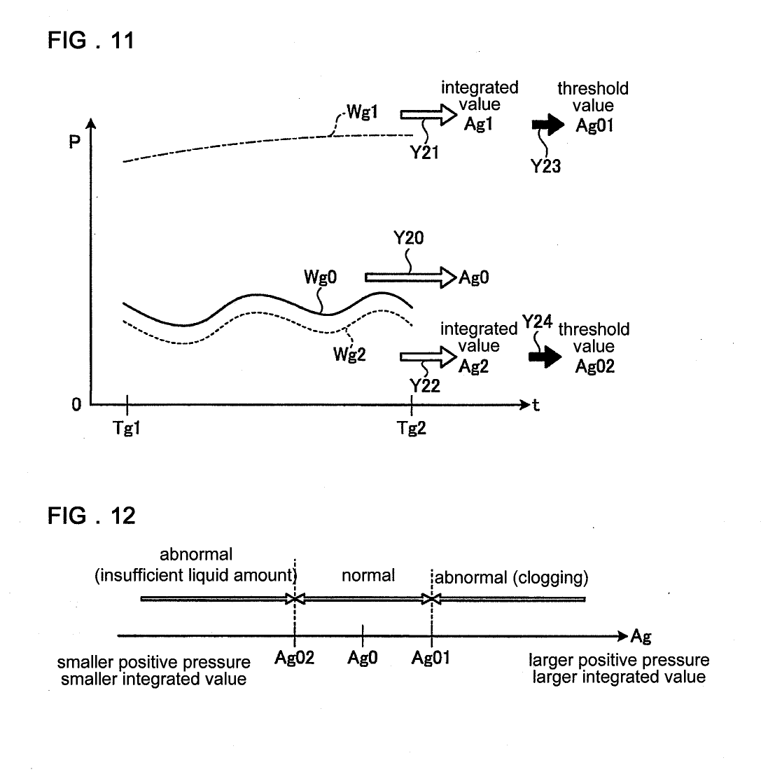

Next, FIG. 11 illustrates each waveform during a predetermined period of time Tg from a time Tg1 to a time Tg2, during which each of pressure waveforms is stabilized. As illustrated in FIG. 11, the waveform Wg1 of abnormal stirring resulting from the occurrence of clogging in a nozzle 2 constantly continues to represent a discharge pressure value higher than the waveform Wg0 of normal stirring. Therefore, regarding an integrated value of discharge pressure values during the predetermined period of time Tg in the case where the nozzle 2 is clogged, an integrated value Ag1 with respected to the waveform Wg1 represented by an arrow Y21 is constantly greater than an integrated value Ag0 with respected to the waveform Wg0 represented by an arrow Y20.

As described above, in the stirring device 201, it is determined whether or not there is an abnormality in a stirring process by using the fact that when the nozzle 2 is clogged, an integrated value of discharge pressure values during the predetermined period of time Tg is constantly greater than the integrated value Ag0 with respect to the waveform Wg0 of normal stirring.

More specifically, the stirring device 201 sets a predetermined threshold value Ag01 as represented by an arrow Y23, on the basis of the integrated value Ag0 of normal stirring and the integrated value Ag1 of abnormal stirring resulting from the occurrence of clogging in the nozzle 2, and determines abnormal stirring due to the occurrence of clogging in the nozzle 2, using the threshold value. The threshold value Ag01 is set on the basis of an integrated value of pressure measurement values within the predetermined period of time Tg of a discharge pressure waveform pre-obtained during normal stirring. The integrated value of pressure measurement values during the predetermined period of time Tg of a discharge pressure waveform pre-obtained during normal stirring, can be obtained by performing a stirring process for a set number of times at normal state, and obtaining an integrated value of pressure measurement values within the predetermined period of time Tg for each stirring process to calculate an average value of the integrated values. In addition, since it is necessary for an accurate amount of a diluent and a stirred sample to be dispensed by the stirring device 201, the threshold value Ag01 is set on the basis of dispensing accuracy of a dispensing device for the dispensing a predetermined amount of liquid, which is stirred by the stirring device 201, for an analyzing process. For example, the threshold value Ag01 is a value obtained by adding 20% to the average value of the integrated values Ag0 of respective pressure measurement values of normal stirring.

Therefore, as illustrated in FIG. 12, when the integrated value of discharge pressure values is more than the threshold value Ag01 during the predetermined period of time Tg, during which each pressure waveform is stabilized, it can be determined that the nozzle 2 is clogged and the stirring process has not been performed in a normal manner.

In addition, as illustrated in FIG. 11, the waveform Wg2 of abnormal stirring resulting from an insufficient liquid amount or the nozzle 2 not reaching a liquid surface, continues to represent a discharge pressure value lower than the waveform Wg0 of normal stirring in most of the cases. Therefore, in the case where the amount of liquid of a stirring subject is not sufficient or the case where the nozzle 2 does not reach a liquid surface, regarding an integrated value of discharge pressure values during the predetermined period of time Tg, the integrated value Ag2 with respect to the waveform Wg2 represented by an arrow Y22 is smaller than the integrated value Ag0 with respect to the waveform Wg0 of normal stirring.

As described above, in the stirring device 201, it is determined whether there is abnormality in the stirring process by using the fact that the integrated value of discharge pressure values during the predetermined period of time Tg is smaller than the integrated value Ag0 with respect to the waveform Wg0 of normal stirring in the case where the amount of liquid of a stirring subject is not sufficient or the case where the nozzle 2 does not reach a liquid surface. More specifically, the stirring device 201 sets a predetermined threshold value Ag02 as represented by an arrow Y24 on the basis of the integrated value Ag0 of normal stirring and the integrated value Ag2 of abnormal stirring resulting from the insufficient amount of liquid or the nozzle 2 not reaching the liquid surface, and determines abnormal stirring due to the insufficient amount of liquid or the nozzle 2 not reaching the liquid surface, using the threshold value Ag02. The threshold value Ag02 is set on the basis of the integrated value of pressure measurement values within the predetermined period of time Tg of the discharge pressure waveform pre-obtained during normal stirring. In addition, since it is necessary for an accurate amount of each of a diluent and a stirred sample to be dispensed by the stirring device 201, the threshold value Ag02 is determined on the basis of dispensing accuracy of a dispensing device for dispensing a predetermined amount of liquid, which is stirred by the stirring device 201, for an analyzing process. For example, the threshold value Ag02 is a value obtained by subtracting 20% from the average value of the integrated values Ag0 of respective pressure measurement values of normal stirring.

Therefore, as illustrated in FIG. 12, when the integrated value of discharge pressure values is less than the threshold value Ag02 during the predetermined period of time Tg, during which each pressure waveform is stabilized, it can be determined that the amount of the liquid is not sufficient or the nozzle 2 does not reach the liquid surface and the stirring process has not been performed in a normal manner.

That is, as illustrated in FIG. 12, when the integrated value of discharge pressure values is within the range from the threshold value Ag02 to the threshold value Ag01 during the predetermined period of time Tg, during which each pressure waveform is stabilized, that is, when the integrated value is within the range of the upper limit of the threshold value Ag01 and the lower limit of the threshold value Ag02, it can be determined that the stirring process is performed in a normal manner in the stirring device 201. In addition, when the integrated value of discharge pressure values is more than the threshold value Ag01, it can be determined that the nozzle 2 is clogged and the stirring process has not been performed in a normal manner. Further, when the integrated value of discharge pressure values is less than the threshold value Ag02, it can be determined that the amount of liquid is not sufficient or the nozzle 2 does not reach the liquid surface, resulting in an abnormal stirring process.

As described above, in the stirring device 201, the presence of an abnormality in the stirring process and the cause of the abnormal stirring are determined on the basis of the integrated value Ag0 of normal stirring and tolerance between the threshold value Ag01 and the threshold value Ag02, which is set on the basis of the dispensing accuracy of a dispensing device for dispensing a predetermined amount of liquid stirred by the stirring device 201. In addition, it is noted that the storing section 36 stores the threshold value Ag01 and the threshold value Ag02.

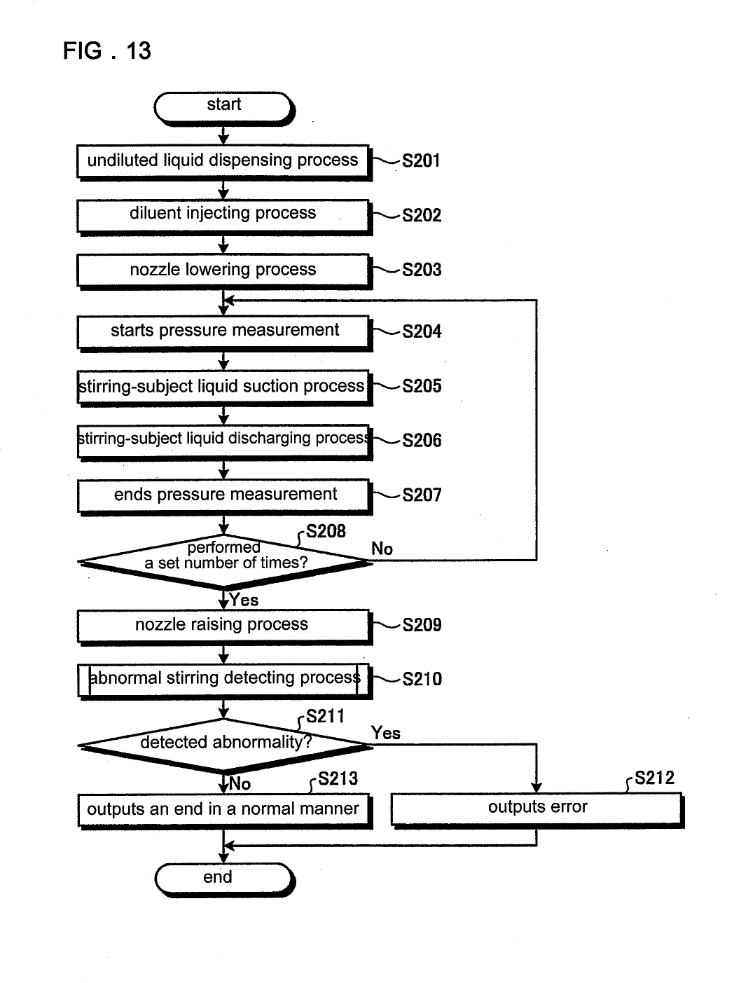

Next, the stirring process in the stirring device 201 will be described with reference to FIG. 13. As illustrated in FIG. 13, the stirring device 201 performs process steps similar to the steps S1 to S9 illustrated in FIG. 5, so as to perform an undiluted solution dispensing process (step S201), a diluent injecting process (step S202), a nozzle lowering process (step S203), a pressure measurement starting process (step S204), a stirring-subject liquid suction process (step S205), a stirring-subject liquid discharging process (step S206), a pressure measurement ending process (step S207), a stirring-subject liquid suction process and stirring-subject liquid discharging process performed for a set number of times determining process (step S208), and a nozzle raising process (step S209).

Next, the abnormality detecting section 235 compares an integrated value of pressure measurement values at discharge, among pressure values added to the nozzle 2 measured by the pressure measuring section 6, with each of threshold values stored in the storing section 36 to perform an abnormal stirring detecting process for detecting the presence of abnormality in the stirring process and a cause of abnormal stirring (step S210).

Next, the stirring device 201 performs process steps similar to the steps S11 to S13 illustrated in FIG. 5, so as to perform an abnormal stirring process detection determining process (step S211), an error output process (step S212) and a stirring process normal end output process (step S213).

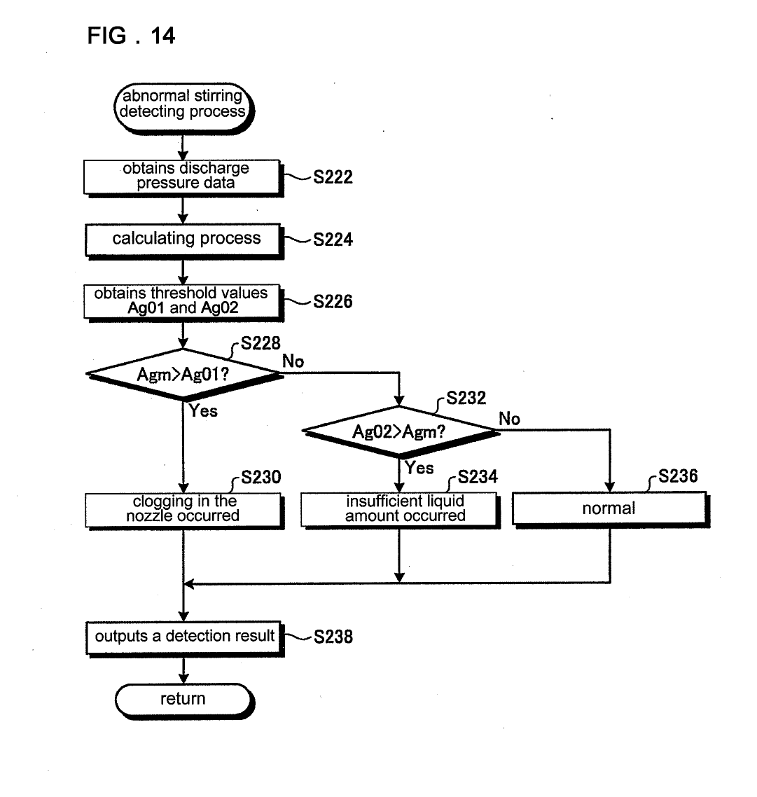

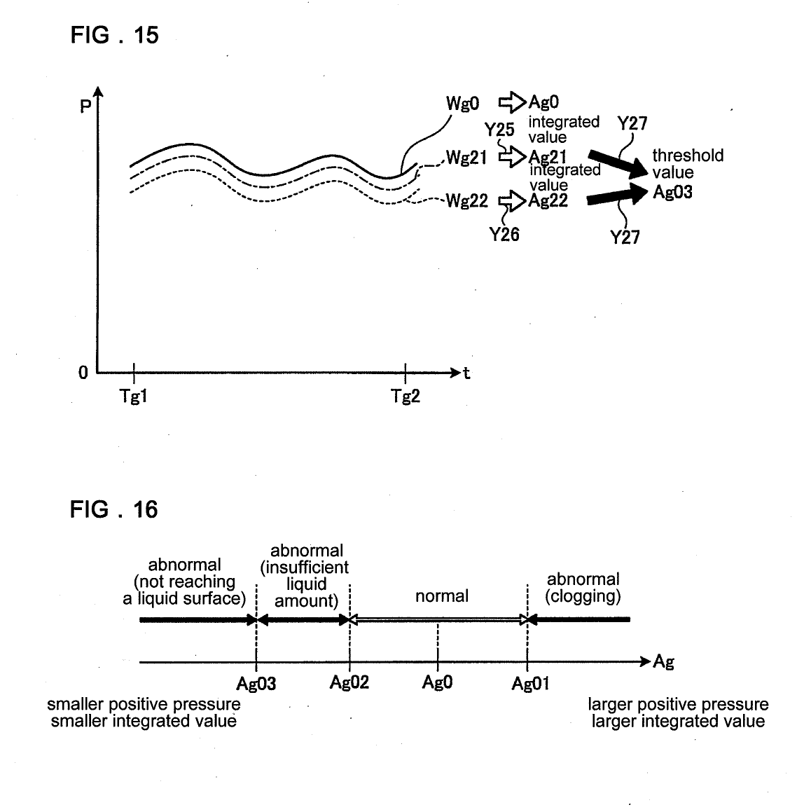

Next, the abnormal stirring detecting process illustrated in FIG. 13 will be described with reference to FIG. 14. As illustrated in FIG. 14, the abnormality detecting section 235 obtains discharge pressure data, which represents a pressure measurement value at discharge, among pressure measurement values measured by the pressure measuring section 6 (step S222). Subsequently, the abnormality detecting section 235 performs a calculating process for integrating pressure measurement values within the predetermined period of time Tg for every set of stirring-subject liquid discharging processes performed a set number of times to calculate an average value Agm of the integrated values (step S224). Next, the abnormality detecting section 235 obtains threshold values Ag01 and Ag02 from the storing section 36 (step S226). The abnormality detecting section 235 detects the presence of an abnormality in the stirring process and a cause of abnormal stirring by comparing the calculated average value Agm of the integrated values and the obtained threshold values Ag01 and Ag02.

First, the abnormality detecting section 235 compares the threshold value Ag01, which is the upper limit of the above-described tolerance, and the calculated average value Agm of the integrated values to determine whether Agm>Ag01 holds (step S228). If the abnormality detecting section 235 determines that Agm>Ag01 (step S228: Yes), that is, if the average value Agm of the integrated values of actual discharge pressure measurement values in the nozzle 2 is more than the threshold value Ag01 and has deviated out of the tolerance, the threshold value being the upper limit of the tolerance and being a reference for determining the occurrence of clogging in the nozzle 2, it is determined that the subject stirring process has not been performed in a normal manner due to the clogging in the nozzle 2 (step S230).

On the other hand, if the abnormality detecting section 235 determines that Agm>Ag01 does not hold (step S228: No), that is, if the average value Agm of the integrated values of actual discharge pressure measurement values in the nozzle 2 is equal to or less than the threshold value Ag01, the threshold value being the upper limit of the tolerance and being a reference for determining the occurrence of clogging in the nozzle 2, the abnormality detecting section 235 compares the threshold value Ag02, which is the lower limit of the above-described tolerance, and the calculated average value Agm of the integrated values to determine whether or not Ag02>Agm holds (step S232).

If the abnormality detecting section 235 determines that Ag02>Agm holds (step S232: Yes), that is, if the average value Agm of the integrated values of actual discharge pressure measurement values in the nozzle 2 is less than the threshold As02 and has deviated out of the tolerance, the threshold being a reference for determining the occurrence of the insufficient liquid amount or the nozzle 2 not reaching the liquid surface and being the lower limit of the tolerance, it is determined that the subject stirring process has not been performed in a normal manner due to the insufficient liquid amount or the nozzle 2 not reaching the liquid surface (step S234). In this case, an abnormality in the transfer controlling of the nozzle transferring section 3 for transferring the nozzle 2, insufficient dispensing amount of the sample Sa by the nozzle 2, or insufficient injecting amount of the diluent La by the nozzle 12 is conceivable.

On the other hand, if the abnormality detecting section 235 determines that Ag02>Agm does not hold (step S232: No), since such a case is where the average value Agm of the integrated values of actual discharge pressure measurement values in the nozzle 2 is within a reference range, it is determined that the stirring process has been performed in a normal manner (step S236). Subsequently, the abnormality detecting section 235 outputs a detection result (step S238), and ends the abnormal stirring detecting process.

As described above, the stirring device 201 according to Embodiment 2 determines whether or not the stirring process has been performed in a normal manner on liquid of a stirring subject in the container, on the basis of the amount of deviation between the discharge pressure waveform measured by the pressure measuring section 6 and the discharge pressure waveform pre-obtained during normal stirring. Thereby, it becomes possible to prevent liquid that is not stirred in a normal manner from being used in an analyzing process, and reduce the waste of reagents and analyzing time in the analyzing process.

In addition, the stirring device 201 determines whether or not the integrated value of discharge pressure measurement values within the predetermined period of time Tg of the discharge pressure waveform measured by the pressure measuring section 6, is within the tolerance range set on the basis of the integrated value of pressure measurement values within the predetermined period of time Tg of discharge pressure waveforms pre-obtained at normal stirring. In other words, the stirring device 201 determines whether there is abnormality in the stirring process using a value obtained by integrating timewise the amounts of deviation from the discharge pressure waveform of normal stirring of a discharge pressure waveform measured by the pressure measuring section 6; and there are a plurality of pressure measurement values to be integrated. Thereby, a more reliable determination can be made as to whether or not there is an abnormality in the stirring process, compared to the case where the determination is made using the amount of deviation at only one point. In addition, in the stirring device 201, the abnormality detecting process is performed on the basis of, not a pressure measurement value in an unstable state, but an integrated value of pressure measurement values during a period when the discharge pressure waveform is stabilized. Thereby, it becomes possible to reduce an influence of deviation in pressure measurement values in an unstable state to perform detecting of abnormalities in a stirring process accurately. Further, in the stirring device 201, each integrated value of pressure measurement values is calculated for each plurality of discharging processes and the abnormality detecting process is performed using the average value of the plurality of integrated values, so that there is a larger number of monitored points and measured discharge pressure values to be averaged, compared to the case where the determination is made using an integrated value of pressure measurement values of only one discharging process, thereby performing a reliable determination on whether or not there is abnormality in a stirring process.

Further, according to Embodiment 2, it is possible to detect, not only the existence of a simple abnormality in a stirring process, but also a cause of the abnormality in the stirring process. Accordingly, a maintenance worker of the stirring device 201 can recognize with which mechanism a cause of abnormality in the stirring process is associated, thereby handling the abnormality in the stirring process of the stirring device quickly and accurately.

Typically, when different liquids of a stirring subject have the same amount and viscosity, a discharge pressure waveform will be substantially the same every time during a stirring process in a normal manner. Therefore, the stirring device 201 may determine the existence of abnormal stirring on the basis of each tolerance range in accordance with each amount and viscosity of liquid to be a stirring subject. More specifically, the stirring device 201 may perform stirring processes in advance with different amounts and viscosities of liquid, and obtain an integrated value of discharge pressure values within a predetermined period of time of a discharge pressure waveform in the stirring processes, and the stirring device 201 may set, on the basis of respective integrated values or the like, a threshold value Ag01, which is the upper limit of a tolerance range, and a threshold value Ag02, which is the lower limit of a tolerance range, corresponding to each amount and each viscosity of liquid.

In addition, according to Embodiment 2, it is also possible to provide a threshold value corresponding to each of the insufficient liquid amount and the nozzle 2 not reaching the liquid surface, to determine in detail which of the insufficient liquid amount or the nozzle 2 not reaching the liquid surface has caused an abnormal stirring process.

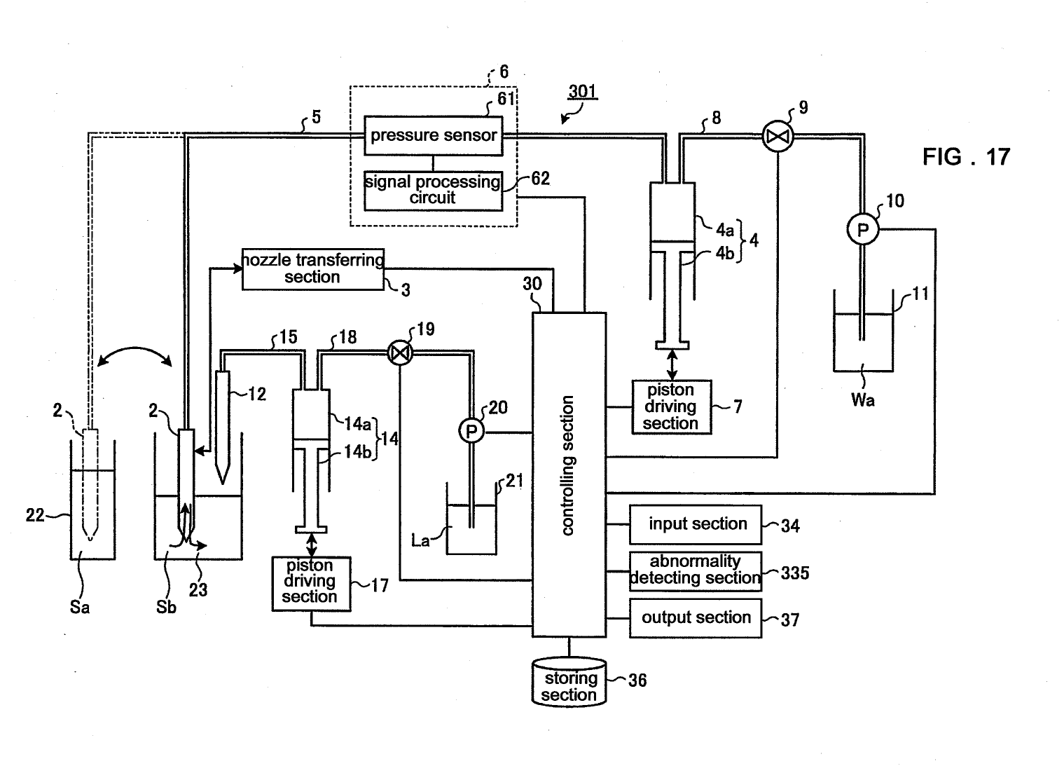

FIG. 15 illustrates a waveform Wg0 representing a discharge pressure waveform of normal stirring as well as a waveform Wg21 representing a discharge pressure waveform of abnormal stirring resulting from an insufficient liquid amount, and a waveform Wg22 representing a discharge pressure waveform of abnormal stirring resulting from the nozzle 2 not reaching a liquid surface. As represented by the waveform Wg21 in FIG. 15, each discharge pressure value of an insufficient liquid amount indicates a value with a lower negative discharge pressure compared to the waveform Wg0 of normal stirring because the amount of discharged liquid is less than a predetermined amount. Further, as represented by the waveform Wg22 in FIG. 15, each discharge pressure value in the case of the nozzle 2 not reaching a liquid surface indicates a value with a still lower negative discharge pressure, compared to the waveform Wg21 in the case of an insufficient liquid amount, because the liquid cannot be discharged. As described above, a certain tendency can be recognized in a value distribution of respective discharge pressure values in the case of an insufficient liquid amount and the case of the nozzle 2 not reaching a liquid surface. In the stirring device 201, this tendency is used and a threshold value is set, which allows to distinguish the case of an insufficient liquid amount from the case of the nozzle 2 not reaching a liquid surface, in addition to the threshold value Ag02, which allows to distinguish whether or not it is normal stirring, to determine which is the cause of the abnormal stirring process, the insufficient liquid amount or the nozzle 2 not reaching a liquid surface.

More specifically, a threshold value Ag03 may be set, which allows to distinguish the case of the insufficient liquid amount from the case of the nozzle 2 not reaching a liquid surface, as represented by an arrow Y27, on the basis of an average value Ag21 of integrated values of discharge pressure values within the predetermined period of time Tg in the waveform Wg21 at an insufficient liquid amount represented by an arrow Y25, and an average value Ag22 of integrated values of discharge pressure values within the predetermined period of time Tg in the waveform Wg22 in the case of the nozzle 2 not reaching a liquid surface represented by an arrow Y26. abnormality detecting section 235 determines that a stirring process has not been performed in a normal manner due to an insufficient liquid amount in a case where an integrated value of discharge pressure values is less than the threshold value Ag02 and is equal to or more than the threshold value Ag03, within a predetermined period of time Tg, during which pressure waveforms are stabilized. In addition, the abnormality detecting section 235 determines that a stirring process has not been performed in a normal manner due to the nozzle 2 not reaching a liquid surface in a case where an integrated value of discharge pressure values is less than the threshold value Ag02 and is still less than the threshold value Ag03, within a predetermined period of time Tg, during which pressure waveforms are stabilized. As described above, by further providing the threshold value Ag03, the stirring device 201 may determine in detail which is the cause of an abnormal stirring process, the insufficient liquid amount or the nozzle 2 not reaching a liquid surface.

### Embodiment 3

Next, Embodiment 3 will be described. In Embodiment 3, a case will be described for detecting abnormality in a stirring process on the basis of both a pressure waveform at liquid suction and a pressure waveform at liquid discharge in a stirring process.

FIG. 17 is a diagram schematically illustrating a structure of a stirring device according to Embodiment 3. As illustrated in FIG. 17, a stirring device 301 according to Embodiment 3 includes an abnormality detecting section 335 instead of the abnormality detecting section 35 illustrated in FIG. 1.

The abnormality detecting section 335 determines whether or not a stirring process has been performed in a normal manner with respect to liquid, on the basis of the amount of deviation between a suction pressure waveform representing a suction pressure change measured by a pressure measuring section 6 and a suction pressure waveform pre-obtained during normal stirring, as well as the amount of deviation between a discharge pressure waveform representing a discharge pressure change measured by the pressure measuring section 6 and a discharge pressure waveform pre-obtained during normal stirring.

The abnormality detecting section 335 herein performs abnormality detection on a stirring process, using an integrated value of suction pressure values measured by the pressure measuring section 6, with the range from the threshold value As01 to the threshold value As02 set in Embodiment 1 as a first tolerance range. In addition, the abnormality detecting section 335 performs abnormality detection on a stirring process, using an integrated value of discharge pressure values measured by the pressure measuring section 6, with the range from the threshold value Ag01 to the threshold value Ag02 set in Embodiment 2 as a second tolerance range.

The abnormality detecting section 335 determines that a stirring process has been performed in a normal manner on liquid when an integrated value of suction pressure measurement values within a predetermined period of time, of a suction pressure waveform measured by the pressure measuring section 6 is within the first tolerance range, which is set on the basis of an integrated value of pressure measurement values within a predetermined period of time of a suction pressure waveform pre-obtained during normal stirring; and when an integrated value of discharge pressure measurement values within a predetermined period of time, of a discharge pressure waveform measured by the pressure measuring section 6 is within the second tolerance range, which is set on the basis of an integrated value of pressure measurement values within a predetermined period of time of a discharge pressure waveform pre-obtained during normal stirring. On the other hand, the abnormality detecting section 335 determines that a stirring process has not been performed in a normal manner on liquid when the integrated value of suction pressure measurement values measured by the pressure measuring section 6 has deviated out of the first tolerance, and/or the integrated value of discharge pressure measurement values measured by the pressure measuring section 6 has deviated out of the second tolerance.

Further, the abnormality detecting section 335 determines that the stirring process has not been performed in a normal manner on the liquid due to an insufficient liquid amount, the nozzle 2 not reaching a liquid surface, the nozzle 2 being clogged, or the nozzle 2 contacting a bottom surface of the container, in accordance with the combination of a case when the integrated value of suction pressure measurement values measured by the pressure measuring section 6 is more than the upper limit of the first tolerance range or a case when the integrated value of suction pressure measurement values measured by the pressure measuring section 6 is less than the lower limit of the first tolerance range, and a case when the integrated value of discharge pressure measurement values measured by the pressure measuring section 6 is more than the upper limit of the second tolerance range or a case when the integrated value of discharge pressure measurement values measured by the pressure measuring section 6 is less than the lower limit of the second tolerance range.

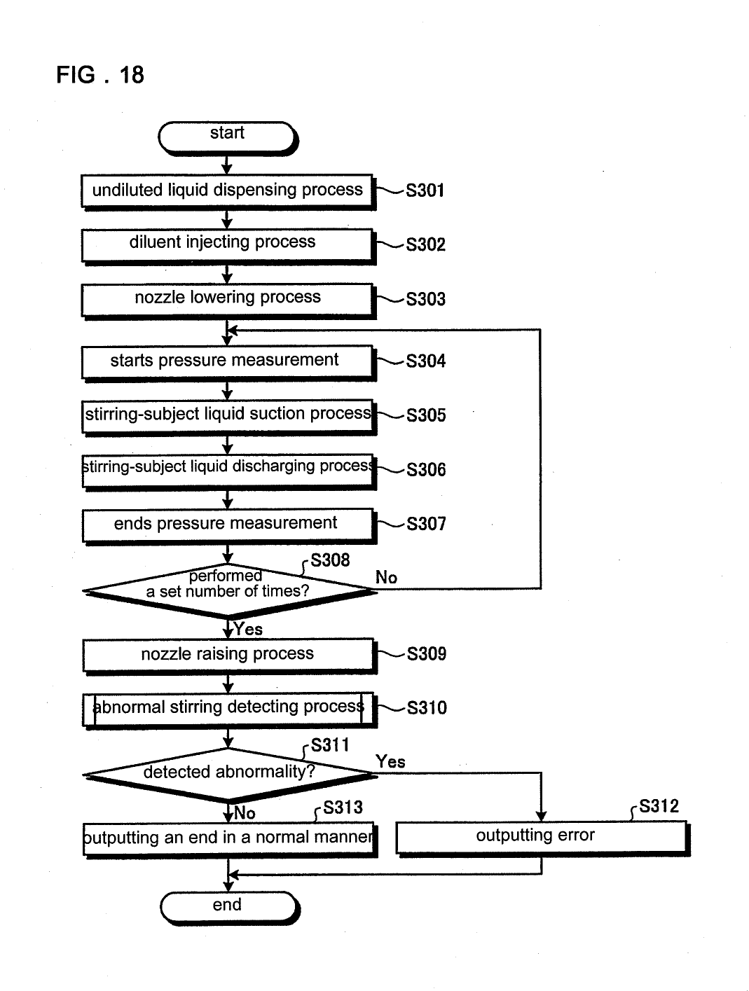

Next, the stirring process in the stirring device 301 will be described with reference to FIG. 18. As illustrated in FIG. 13, the stirring device 301 performs process steps similar to the steps S1 to S9 illustrated in FIG. 5, so as to perform an undiluted solution dispensing process (step S301), a diluent injecting process (step S302), a nozzle lowering process (step S303), a pressure measurement starting process (step S304), a stirring-subject liquid suction process (step S305), a stirring-subject liquid discharging process (step S306), a pressure measurement ending process (step S307), a stirring-subject liquid suction process and stirring-subject liquid discharging process performed for a set number of times determining process (step S308), and a nozzle raising process (step S309).

Next, the abnormality detecting section 335 compares an integrated value of pressure measurement values within suction and an integrated value of pressure measurement values within discharge measured by the pressure measuring section 6, with each of threshold values stored in a storing section 36 to perform an abnormal stirring detecting process for detecting the presence of abnormalities in the stirring process and a cause of abnormal stirring (step S310).

Next, the stirring device 301 performs process steps similar to the steps S11 to S13 illustrated in FIG. 5, so as to perform an abnormal stirring process detection determining process (step S311), an error output process (step S312) and a stirring process normal end output process (step S313).

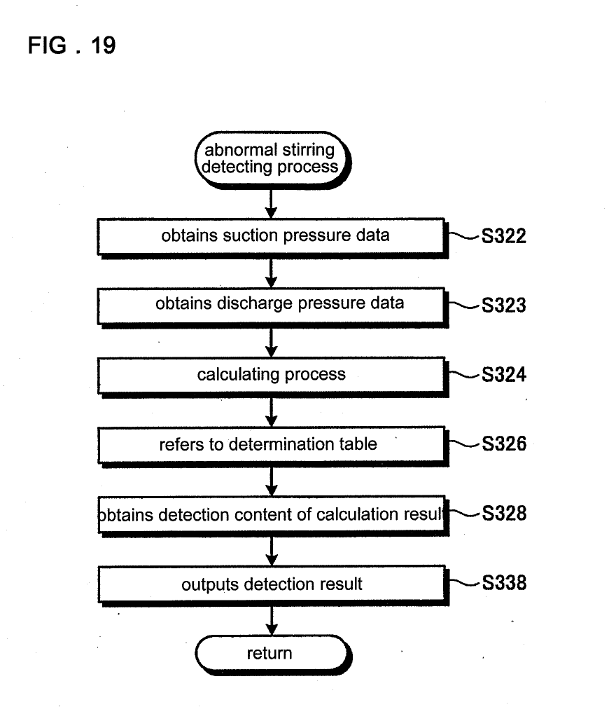

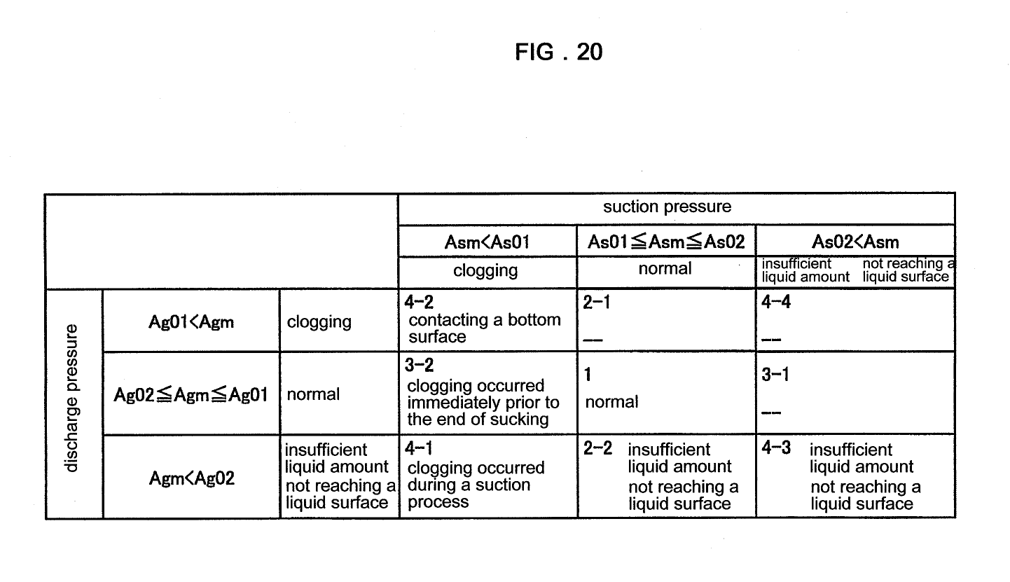

Subsequently, the abnormal stirring detecting process illustrated in FIG. 18 will be described with reference to FIG. 19. As illustrated in FIG. 19, the abnormality detecting section 335 obtains suction pressure data, which represents a pressure measurement value at suction (step S322), and subsequently, obtains discharge pressure data, which represents a pressure measurement value at discharge (step S323), among pressure measurement values measured by the pressure measuring section 6. Subsequently, the abnormality detecting section 335 performs a calculating process for integrating pressure measurement values within the predetermined period of time Ts for every set of stirring-subject liquid discharging processes performed a set number of times to calculate an average value Asm of the integrated values as well as integrating pressure measurement values within the predetermined period of time Tg for every set of stirring-subject liquid discharging processes performed a set number of times to calculate an average value Agm of the integrated values (step S324).

Subsequently, the abnormality detecting section 335 refers to a determination table from the storing section 36, the determination table representing contents of abnormality detected in a stirring process corresponding to each combination of the average values Asm and Agm of integrated values (step S326). The abnormality detecting section 335 obtains a detection result with respect to a stirring process, corresponding to a combination of the Asm and Agm, which are calculation results, by referring to the determination table (step S328), and outputs the obtained detection result (step S338), thus ending the abnormal stirring detecting process.

For example, as illustrated in FIG. 20, the determination table shows combinations of the average value

Asm of integrated values in suction pressure data and the average value Agm of integrated values in discharge pressure data, with corresponding results of whether or not there is abnormality in a stirring process as well as corresponding cause of abnormality; and the determination table is stored in the storing section 36.

A case with a combination number “1” will be described. This is a case where the average value Asm of integrated values in suction pressure data is equal to or more than the As01 and is equal to or less than the As02, and is within the first tolerance range, and where the average value Agm of integrated values in discharge pressure data is equal to or more than the Ag02 and is equal to or less than the Ag01, and is within the second tolerance range. In such a case with the combination number “1”, the tolerance range is satisfied both in the suction and discharge, and therefore, the abnormality detecting section 335 determines that the subject stirring process has been performed in a normal manner.

In addition, a case with a combination number “2-2” will be described. This is a case where the average value Asm of integrated values in suction pressure data is equal to or more than the As01 and is equal to or less than the As02, and is within the first tolerance range, but where the average value Agm of integrated values in discharge pressure data is less than the Ag02. In this case, since the average value Agm of integrated values in discharge pressure data is less than the threshold value Ag02 and has deviated out of the tolerance range, the threshold value being the lower limit of the tolerance range and being a reference for determining the occurrence of an insufficient liquid amount or the nozzle 2 not reaching a liquid surface, it can be determined that an insufficient liquid amount or the nozzle 2 not reaching a liquid surface has occurred in a discharging process for stirring-subject liquid. In such a case with the combination number “2-2” as described above, the abnormality detecting section 335 determines that the subject stirring process has not been performed in a normal manner due to an insufficient liquid amount or the nozzle 2 not reaching a liquid surface at a discharging process. In the case with the combination number “2-2”, the average value is determined as being within the tolerance range in the suction process, and therefore, the insufficient liquid amount is insignificant compared to a case with “4-3” to be described later.

When the average value Agm of integrated values in discharge pressure data is more than the Ag01 herein, it is when the nozzle 2 is clogged during a discharging process. In addition, in order for the nozzle 2 to be in a clogged condition during a discharging process for discharging sucked liquid, it can be said that such is a case where the nozzle 2 was already clogged during a suction process prior to the discharging process. Therefore, when the average value Agm of integrated values in discharge pressure data is more than the threshold value Ag01, it is apparent that the average value Asm of integrated values will be less than the threshold value As01 resulting from the clogging in the nozzle 2 during the suction process, as well. Thus, it is considered that a case with a combination number “2-1”, that is, a case where the average value Asm of integrated values in suction pressure data is equal to or more than the threshold value As01 and is equal to or less than the threshold value As02 as well as the average value Agm of integrated values in discharge pressure data is more than the threshold value Ag01, will not occur.

Further, a case with a combination number “3-2” will be described. This is a case where the average value Agm of integrated values in discharge pressure data is equal to or more than the Ag02 and is equal to or less than the Ag01 and is within the second tolerance range, but where the average value Asm of integrated values in suction pressure data is less than the As01. That is, this is a case where the average value Asm of integrated values in suction pressure data is less than the threshold value As01 and has deviated out of the tolerance range, the threshold value being the lower limit of the tolerance range and being a reference for determining the occurrence of clogging in the nozzle 2, but the average value Agm of integrated values in discharge pressure data is normal. In this case, although abnormality is recognized in the suction process resulting from clogging in the nozzle 2, the discharging process is performed in a normal manner. Thus, it can be considered that although clogging occurred in the nozzle 2 immediately prior to the end of the suction process of stirring-subject liquid, the clogging was solved at discharge and the amount of suction is at a level with substantially no problem. The insufficient liquid amount in the case with the combination number “3-2” is insignificant compared to a case with “4-1” to be described later.

When the average value Asm of integrated values in suction pressure data is more than the As02 herein, it is when a set predetermined amount of liquid was not sucked due to the insufficient liquid amount or the nozzle 2 not reaching a liquid surface during a suction process. In addition, when it is only able to suck an amount of liquid that is less than the set amount, it means that only an amount of liquid that is less than the set amount can be discharged at a discharging process. Therefore, when the average value Asm of integrated values in suction pressure data is more than the As02, it is apparent that the average value Agm of integrated values will be less than the threshold value Ag02 resulting from an insufficient liquid amount or the nozzle 2 not reaching a liquid surface. Thus, it is considered that a case with a combination number “3-1”, that is, a case where the average value Asm of integrated values in suction pressure data is more than the threshold value As02 as well as the average value Agm of integrated values in discharge pressure data is equal to or more than the threshold value Ag02 and is equal to or less than the threshold value Ag01, will hardly ever occur. However, when the volume at suction is barely at the threshold value and the volume is immeasurable, there is a possibility for such a case to be a case with the combination number “3-1”.

Next, a case with a combination number “4-1” will be described. The case with the combination number “4-1” is when the average value Asm of integrated values in suction pressure data is less than the threshold value As01, which is a reference for determining the occurrence of clogging in the nozzle 2, and the average value Agm of integrated values in discharge pressure data is less than the threshold value Ag02, which is a reference for determining an insufficient liquid amount or the nozzle 2 not reaching a liquid surface. This is considered to be the case where the amount of discharged liquid is insufficient at a discharging process as a result that the nozzle 2 was clogged during a suction process and thus the amount of liquid sucked was small. Thus, in the case with the combination number “4-1”, the abnormality detecting section 335 determines that the subject stirring process has not been performed in a normal manner due to the occurrence of clogging during the suction process.

Next, a case with a combination number “4-2” will be described. This is a case where the average value Asm of integrated values in suction pressure data is less than the threshold value As01, which is a reference for determining the occurrence of clogging in the nozzle 2, and the average value Agm of integrated values in discharge pressure data is more than the threshold value Ag01, which is a reference for determining the occurrence of clogging in the nozzle 2. For a case such as this, a case can be considered where the nozzle 2 is clogged from the beginning of suction and liquid is not sucked at all, for example, a case where the nozzle 2 contacts a bottom surface of the stirring container 23 with stirring-subject liquid contained therein. Thus, in the case with the combination number “4-2”, the abnormality detecting section 335 determines that the subject stirring process has not been performed in a normal manner due to the nozzle contacting the bottom surface of the stirring container 23. It is noted that in the case with the combination number “4-2”, there is also a possibility that the case is due to simple clogging.

Next, a case with a combination number “4-3” will be described. This is a case where the average value Asm of integrated values in suction pressure data is more than the threshold value As02, which is a reference for determining the occurrence of an insufficient liquid amount or the nozzle 2 not reaching a liquid surface, and the average value Agm of integrated values in discharge pressure data is less than the threshold value Ag02, which is a reference for determining an insufficient liquid amount or the nozzle 2 not reaching a liquid surface. This is considered to be the case when an insufficient liquid amount or the nozzle 2 not reaching a liquid surface has occurred both during a suction process and during a discharging process. When it is a case with the combination number “4-3”, the abnormality detecting section 335 determines that the subject stirring process has not been performed in a normal manner due to an insufficient liquid amount or the nozzle 2 not reaching a liquid surface both during a suction process and during a discharging process. The case with the combination number “4-3” means a completely insufficient liquid amount.

As previously described, it is apparent that the nozzle 2 was already clogged at a suction process when the average value Agm of integrated values in discharge pressure data is more than the Ag01 and the nozzle 2 is clogged at a discharging process. Accordingly, it is apparent that when the average value Agm of integrated values in discharge pressure data is more than the threshold value Ag01, the average value Asm of integrated values will be less than the threshold value As01 due to clogging in the nozzle 2, during a suction process, as well. Thus, it is considered that the case with a combination number “4-4”, that is, the case where the average value Asm of integrated values in suction pressure data is more than the threshold value As02, which is a reference for determining the occurrence of an insufficient liquid amount or the nozzle 2 not reaching a liquid surface, and the average value Agm of integrated values in discharge pressure data is more than the threshold value Ag01, will not occur.

As described above, the stirring device 301 according to Embodiment 3 uses both of the suction pressure waveform and the discharge pressure waveform measured by the pressure measuring section 6, so that it becomes possible to detect the presence of an abnormality in a stirring process more reliably and detect a cause of the abnormality in the stirring process in detail, compared to a case where either one of the suction pressure waveform or the discharge pressure waveform is used.

In addition, in the stirring devices 1, 201 and 301 according to Embodiments 1 to 3, the rate of upward and downward driving by the piston 4b may be set so that pressure measurement can be reliably performed by the pressure measuring section 6. In the dispensing device, the rate of upward and downward driving by the piston therein is precisely controlled so that a predetermined amount of liquid can be dispensed accurately. On the contrary, it is enough for the stirring devices 1, 201 and 301 to be able to stir liquid sufficiently, and therefore, high dispensing accuracy is not particularly required of the stirring devices 1, 201 and 301. Therefore, in the stirring devices 1, 201 and 301, in order to obtain many pressure measurement points by the pressure measuring section 6, the upward and downward driving rate by the piston 4b maybe adjusted in accordance with the pressure measurement timing by the pressure measuring section 6. For example, the upward and downward driving rate can be slowed down than the upward and downward driving rate by the piston in the dispensing device by referring to the measurement timing of the pressure measuring section 6. As a result, it becomes possible to detect abnormal stirring in the stirring devices 1, 201 and 301 with certain accuracy.

In addition, in the stirring devices 1, 201 and 301 according to Embodiments 1 to 3, abnormality is detected in a stirring process on the basis of a pressure value applied to the nozzle 2, and abnormality can be detected in a stirring process as long as there is an enough amount of stirring-subject liquid for pressure measurement. Therefore, abnormalities can be detected sufficiently in a stirring process with respect to a small amount of stirring-subject liquid. In addition, in the stirring devices 1, 201 and 301 according to Embodiments 1 to 3, an abnormality is detected in a stirring process using a pressure value applied to the nozzle 2. Therefore, abnormalities can be detected in a stirring process of stirring-subject liquid without the stirring-subject liquid having particular characteristics, such as conductivity.

The stirring devices 1, 201 and 301 according to Embodiments 1 to 3 can be applied as a stirring device in an analyzer for analyzing a sample, such as blood and urine. In this case, the stirring devices 1, 201 and 301 is applied as a stirring device for diluting a sample, such as blood and urine, with a predetermined diluent. More specifically, an analyzer which is applied with the stirring device 1 will be described, among the stirring devices 1, 201 and 301.

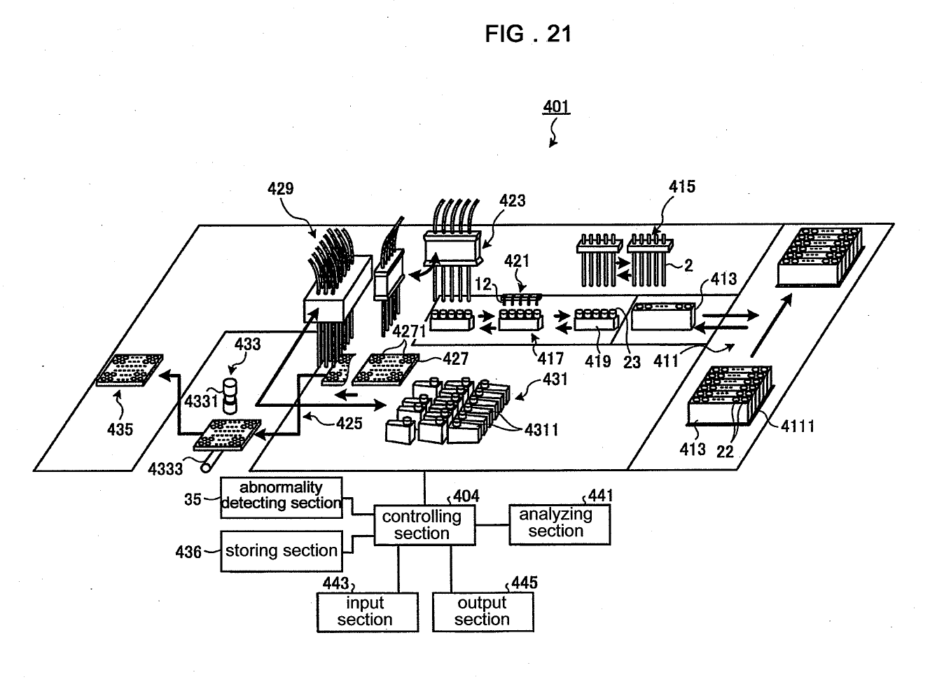

FIG. 21 is a schematic perspective view illustrating an exemplary internal structure of an analyzer applied with the stirring device 1 illustrated in FIG. 1. As illustrated in FIG. 21, an analyzer 401 herein is a device for performing immunological testing, such as an antigen-antibody reaction of test blood, using an immunological agglutination reaction. The analyzer 401 includes: a sample rack conveying section 411; a sample dispensing section 415; a diluted sample rack conveying section 417; a diluent dispensing section 421; a diluted sample dispensing section 423; a plate conveying section 425; a reagent dispensing section 429; a reagent storing section 431; a measuring section 433; and a plate collecting section 435.

The sample rack conveying section 411 conveys a sample rack 413 arranged in a rack feeder 4111, under the control of a controlling section 404 to be described later. The sample rack 413 is loaded with a plurality of containers 22, which contain samples (specimens), and the sample rack conveying section 411 successively transfers the sample rack 413 to convey the containers 22 to a predetermined sample suction position.

In the meantime, at a predetermined diluent dispense position, a predetermined amount of a diluent is dispensed into each of stirring containers 23 in a diluted sample rack 419 by the diluent dispensing section 421 including a plurality of nozzles 12 for discharging a diluent. The stirring containers 23 which are dispensed with the diluent are transferred to a predetermined sample discharge position.

The sample dispensing section 415 includes a nozzle 2 for sucking and discharging a sample. Under the control of the controlling section 404, the sample dispensing section 415 performs dispensing by sucking the sample in the container 22 by the nozzle 2, the container 22 being transferred to the sample suction position, and successively discharging the sucked sample into each of the stirring containers 23 at the predetermined sample discharge position. Subsequently, through a suction process and a discharging process, the dispensed sample and the diluent are stirred.

The diluted sample dispensing section 423 includes a plurality of sample nozzles for performing suction and discharge of a diluted sample. Under the control of the controlling section 404, the diluted sample dispensing section 423 sucks a diluted sample by each sample nozzle from each of the stirring containers 23 in the diluted sample rack 419 transferred to a diluted sample suction position, and transfers the diluted sample to a diluted sample discharge position. A microplate 427 is placed at the diluted sample discharge position, the microplate 427 being constituted of a plurality of reaction containers 4271, referred to as a well, arranged in a matrix thereon. The diluted sample dispensing section 423 performs dispensing by discharging each diluted sample into each of the reaction containers 4271 of the microplate 427.

In order to dispense the diluted sample and a reagent into each of the reaction containers 4271 of the microplate 427 and measure mixed liquid of the diluted sample and the reagent in each of the reaction containers 4271, under the control of the controlling section 404, the plate conveying section 425 transfers the microplate 427 at the diluted sample discharge position and conveys the reaction containers 4271 to a reagent discharge position, and subsequently conveys them to a measurement position. A reagent is dispensed by a reagent dispensing section 429 into the reaction containers 4271 conveyed to the reagent discharge position.

The reagent dispensing section 429 includes reagent nozzles, each of which performs suction and discharge of a reagent. Under the control of the controlling section 404, the reagent dispensing section 429 sucks a reagent in each of reagent containers 4311 of a reagent storing section 431 by each reagent nozzle, and transfers the reagent to a reagent discharge position. Subsequently, the reagent dispensing section 429 discharges the reagent into the reaction containers 4271 conveyed by the plate conveying section 425 to the reagent discharge position. The reagent storing section 431 stores a plurality of reagent containers 4311 arranged therein, each of which contains a predetermined reagent that causes an antigen-antibody reaction with a sample.

The microplate 427 is conveyed to the measurement position by the plate conveying section 425 after the diluted sample is dispensed into the reaction containers 4271 by the diluted sample dispensing section 423, a reagent is dispensed into the reaction containers 4271 by the reagent dispensing section 429, and an antigen-antibody reaction is completed with the sample in the reaction containers 4271 with the elapse of a necessary reaction time. By the antigen-antibody reaction, an aggregation reaction pattern is formed at a bottom surface of each of the reaction containers 4271.

The measuring section 433 includes: an image capturing section 4331, such as a CCD camera, provided above a measurement position, for capturing from above an image of a microplate 427 conveyed to the measurement position; and a light source 4333 provided below the measurement position, for radiating irradiation light on reaction containers 4271 of the microplate 427. The image capturing section 4331 receives light that has passed through the reaction containers 4271 to capture an image of an aggregation reaction pattern formed on the bottom surface each of the reaction containers 4271. The obtained measurement result (image information) is output to the controlling section 404. Typically, with regard to a positive sample, aggregation takes place with a sample and a reagent; and with regard to a negative sample, aggregation does not take place with a sample and a reagent.

The plate collecting section 435 collects a microplate 427 which has ended with measurement by the measuring section 433. The collected microplate 427 is cleaned in a cleaning section (not shown) to be re-used. More specifically, mixed liquid in the reaction containers 4271 is discharged, and cleaning is performed by discharge and suction of cleaning liquid, such as a detergent or cleaning water. There is a case where the microplate 427 is thrown away after completion of one measurement depending on the content of testing.

In addition, the analyzer 401 includes a controlling section 404 for controlling sections which constitute the analyzer by instructing operational timings, transferring data and the like to the sections to control operation of the overall analyzer comprehensively. The controlling section 404 is constituted of a microcomputer or the like, which includes a memory built therein for storing, in addition to an analysis result, various data necessary for the operation of the analyzer 401, and the controlling section 404 is placed at an appropriate position in the analyzer 401. The controlling section 404 is connected with an analyzing section 441 and outputs a measurement result by the measuring section 433 to the analyzing section 441. The analyzing section 441 analyzes an antigen-antibody reaction on the basis of a measurement result by the measuring section 433, and outputs an analysis result to the controlling section 404. For example, the analyzing section 441 performs image processing on image information obtained by the measuring section 433 to detect and judge an aggregation reaction pattern formed on each bottom surface of reaction containers 4271. In addition, the controlling section 404 is connected with an input section 443 constituted of an input device, such as a keyboard and a mouse, for inputting information necessary for analysis, such as the number of samples and analysis items; and an output section 445 constituted of a display device and the like, such as an LCD and an ELD, for displaying an analysis result screen, a warning screen, an input screen for inputting various settings and the like. In addition, similar to the stirring device 1 illustrated in FIG. 1, the analyzer 401 includes: an abnormality detecting section 35 for detecting abnormality in a stirring process in the diluent dispensing section 421; and a storing section 436 for storing various information used for an abnormality detecting process by the abnormality detecting section 35.

As described above, the analyzer 401 includes the stirring device 1, 201 or 301 according to Embodiments 1 to 3, thereby preventing a sample and a diluent which are not stirred in a normal manner from being used in an analyzing process to improve analysis accuracy.

The stirring devices 1, 201 and 301 and the analyzer 401 described in the above embodiments can be achieved by executing a prepared program in a computer system. The computer system achieves processing operation of the analyzer by reading and executing a program recorded in a predetermined recording medium. Herein, the predetermined recording medium can be any recording medium for recording a program readable by a computer system, including a “portable medium”, such as a flexible disk (FD), a CD-ROM, an MO disk, a DVD disk, a magneto-optical disk and an IC card, as well as a “communication medium” for storing a program for a short period of time in transmitting the program, such as a hard disk drive (HDD) provided either inside or outside the computer system. In addition, the computer system achieves processing operation of the stirring device and analyzer by obtaining a program from a management server or other computer system connected via a network line and executing the obtained program.

### INDUSTRIAL APPLICABILITY

As described above, the stirring device and analyzer according to the present invention is suitable for correctly detecting abnormalities in a stirring process and preventing liquid which has not been stirred in a normal manner from being used in an analyzing process.

1. A stirring device for repeating suction and discharge of liquid in a container to stir the liquid, comprising:
a nozzle for sucking or discharging the liquid;
a pressure generating section for generating pressure necessary for the nozzle to suck or discharge the liquid;
a pressure measuring section for measuring pressure generated by the pressure generating section and applied to the nozzle; and
a determining section for determining whether or not a stirring process has been performed on the liquid in a normal manner, on the basis of an amount of deviation between a suction pressure waveform indicating a suction pressure change measured by the pressure measuring section, and a suction pressure waveform pre-obtained during normal stirring.

2. The stirring device according to claim 1, wherein the determining section determines that the stirring process has been performed on the liquid in a normal manner when an integrated value of suction pressure measurement values within a predetermined period of time of the suction pressure waveform measured by the pressure measuring section is within a first tolerance range, which is set on the basis of an integrated value of pressure measurement values within the predetermined period of time of the suction pressure waveform pre-obtained during normal stirring; and determines that the stirring process has not been performed on the liquid in a normal manner when the integrated value of the suction pressure measurement values measured by the pressure measuring section has deviated out of the first tolerance range.

3. The stirring device according to claim 2, wherein the determining section determines that the stirring process has not been performed on the liquid in a normal manner due to an insufficient liquid amount or the nozzle not reaching a liquid surface, when the integrated value of the suction pressure measurement values measured by the pressure measuring section is more than an upper limit of the first tolerance range; and determines that the stirring process has not been performed on the liquid in a normal manner due to clogging in the nozzle, when the integrated value of the suction pressure measurement values measured by the pressure measuring section is less than a lower limit of the first tolerance range.

4. A stirring device for repeating suction and discharge of liquid in a container to stir the liquid, comprising:
a nozzle for sucking or discharging the liquid;
a pressure generating section for generating pressure necessary for the nozzle to suck or discharge the liquid;
a pressure measuring section for measuring pressure generated by the pressure generating section and applied to the nozzle; and
a determining section for determining whether or not a stirring process has been performed on the liquid in a normal manner, on the basis of an amount of deviation between a discharge pressure waveform indicating a discharge pressure change measured by the pressure measuring section, and a discharge pressure waveform pre-obtained during normal stirring.

5. The stirring device according to claim 4, wherein the determining section determines that the stirring process has been performed on the liquid in a normal manner when an integrated value of discharge pressure measurement values within a predetermined period of time of the discharge pressure waveform measured by the pressure measuring section is within a second tolerance range, which is set on the basis of an integrated value of pressure measurement values within the predetermined period of time of the discharge pressure waveform pre-obtained during normal stirring; and determines that the stirring process has not been performed on the liquid in a normal manner when the integrated value of the discharge pressure measurement values measured by the pressure measuring section has deviated out of the second tolerance range.

6. The stirring device according to claim 5, wherein the determining section determines that the stirring process has not been performed on the liquid in a normal manner due to clogging in the nozzle, when the integrated value of the discharge pressure measurement values measured by the pressure measuring section is more than an upper limit of the second tolerance range; and determines that the stirring process has not been performed on the liquid in a normal manner due to an insufficient liquid amount or the nozzle not reaching a liquid surface, when the integrated value of the discharge pressure measurement values measured by the pressure measuring section is less than a lower limit of the second tolerance range.

7. A stirring device for repeating suction and discharge of liquid in a container to stir the liquid, comprising:
a nozzle for sucking or discharging the liquid;
a pressure generating section for generating pressure necessary for the nozzle to suck or discharge the liquid;
a pressure measuring section for measuring pressure generated by the pressure generating section and applied to the nozzle; and
a determining section for determining whether or not a stirring process has been performed on the liquid in a normal manner, on the basis of an amount of deviation between a suction pressure waveform indicating a suction pressure change measured by the pressure measuring section, and a suction pressure waveform pre-obtained during normal stirring as well as an amount of deviation between a discharge pressure waveform indicating a discharge pressure change measured by the pressure measuring section, and a discharge pressure waveform pre-obtained during normal stirring.

8. The stirring device according to claim 7, wherein the determining section determines that the stirring process has been performed on the liquid in a normal manner when an integrated value of suction pressure measurement values within a predetermined period of time of the suction pressure waveform measured by the pressure measuring section is within a first tolerance range, which is set on the basis of an integrated value of pressure measurement values within the predetermined period of time of the suction pressure waveform pre-obtained during normal stirring, and when an integrated value of discharge pressure measurement values within a predetermined period of time of the discharge pressure waveform measured by the pressure measuring section is within a second tolerance range, which is set on the basis of an integrated value of pressure measurement values within the predetermined period of time of the discharge pressure waveform pre-obtained during normal stirring; and determines that the stirring process has not been performed on the liquid in a normal manner when the integrated value of the suction pressure measurement values measured by the pressure measuring section has deviated out of the first tolerance range and/or when the integrated value of the discharge pressure measurement values measured by the pressure measuring section has deviated out of the second tolerance range.

9. The stirring device according to claim 8, wherein the determining section determines that the stirring process has not been performed on the liquid in a normal manner due to an insufficient liquid amount, the nozzle not reaching a liquid surface, clogging in the nozzle or the nozzle contacting a bottom surface of the container, in accordance with each combination of: when the integrated value of the suction pressure measurement values measured by the pressure measuring section is more than the upper limit of the first tolerance range; or when the integrated value of the suction pressure measurement values measured by the pressure measuring section is less than the lower limit of the first tolerance range; as well as when the integrated value of the discharge pressure measurement values measured by the pressure measuring section is more than the upper limit of the second tolerance range; or when the integrated value of the discharge pressure measurement values measured by the pressure measuring section is less than the lower limit of the second tolerance range.

10. The stirring device according to claim 2, wherein the first tolerance range is set on the basis of the integrated value of pressure measurement values within the predetermined period of time of the suction pressure waveform pre-obtained during normal stirring, and dispensing accuracy of a dispensing device for dispensing the liquid stirred by the stirring device.

11. The stirring device according to claim 5, wherein the second tolerance range is set on the basis of the integrated value of pressure measurement values within the predetermined period of time of the discharge pressure waveform pre-obtained during normal stirring, and dispensing accuracy of a dispensing device for dispensing the liquid stirred by the stirring device.

12. The stirring device according to claim 2, wherein:
the pressure measuring section measures pressure applied to the nozzle for each suction process at the nozzle; and
the determining section calculates an average value of integrated values of suction pressure measurement values at suction processes measured by the pressure measuring section, and compares the calculated average value of the integrated values with the first tolerance range to determine whether or not the stirring process has been performed on the liquid in a normal manner.

13. The stirring device according to claim 5, wherein:
the pressure measuring section measures pressure applied to the nozzle for each discharge process at the nozzle; and
the determining section calculates an average value of integrated values of discharge pressure measurement values at discharge processes measured by the pressure measuring section, and compares the calculated average value of the integrated values with the second tolerance range to determine whether or not the stirring process has been performed on the liquid in a normal manner.

14. The stirring device according to claim 2 wherein the predetermined period of time is a period of time when a pressure waveform shape measured by the pressure measuring section is stabilized.

15. An analyzer comprising the stirring device according to claim 1.
